(19) United States
(12) Patent Application Publication
(10) Pub. No.: US 2025/0231681 A1
(43) Pub. Date: Jul. 17, 2025

(54) METHOD AND APPARATUS FOR DISPLAYING TOUCH CONTROL, DEVICE, AND STORAGE MEDIUM

(71) Applicant: Tencent Technology (Shenzhen) Company Limited, Shenzhen (CN)

(72) Inventor: Jun Jiang, Shenzhen (CN)

(21) Appl. No.: 19/171,951

(22) Filed: Apr. 7, 2025

Related U.S. Application Data
(63) Continuation of application No. PCT/CN2024/076546, filed on Feb. 7, 2024.

(30) Foreign Application Priority Data
Apr. 17, 2023 (CN) 2023104325779

(51) Int. Cl. G06F 3/04883; A63F 13/2145

(52) U.S. Cl. CPC G06F 3/04883; A63F 13/2145

(57) ABSTRACT

Methods and systems for displaying touch controls are described herein. A method may include displaying the touch control by using a first position in a user interface as a display position of the touch control, receiving a plurality of touch operation instructions generated by performing a plurality of touch operations on the touch control, determining a plurality of touch operation positions respectively corresponding to the plurality of touch operation instructions on the user interface, adjusting the display position from the first position to a second position in the user interface based on the plurality of touch operation positions, and displaying the touch control at the second position. This application provides techniques for adjusting the display position of the touch control based on the plurality of touch operations for the touch control, which improves the service efficiency of the touch control and improves convenience in operation.

### CROSS-REFERENCE TO RELATED APPLICATIONS

This application is a continuation application of PCT Application PCT/CN2024/076546, filed Feb. 7, 2024, which claims priority to Chinese Patent Application No. 2023104325779, filed on Apr. 17, 2023, each entitled “METHOD AND APPARATUS FOR DISPLAYING TOUCH CONTROL, DEVICE, AND STORAGE MEDIUM”, and each of which is incorporated herein by reference in its entirety.

### FIELD

Aspects described herein relate to the field of user interfaces, and in particular, to a touch control display technology.

### BACKGROUND

In online games with virtual environments, such as multiplayer online role-playing games, players may play one or more virtual characters and control their activities within the virtual environment of the game.

In related arts, virtual characters are controlled to move in the virtual environment by touching a plurality of touch controls displayed in the user interface. Usually, the display positions of the touch controls are default and fixed, and players may also adjust the display position of touch controls through customization to make them more conform to their operating habits.

However, manually adjusting the display positions of the touch controls requires repeated attempts, which requires players to switch between a plurality of user interfaces, resulting in poor convenience and low adjustment efficiency.

### SUMMARY

This application provides a method and apparatus for displaying a touch control, a device, and a storage medium. Technical solutions are as follows:

According to one aspect, this application provides a method for displaying a touch control, the method being executed by a terminal and including:
displaying the touch control by using a first position in a user interface as a display position of the touch control;
receiving a plurality of touch operation instructions generated by performing a plurality of touch operations on the touch control;
determining a plurality of touch operation positions respectively corresponding to the plurality of touch operation instructions on the user interface; and
adjusting the display position from the first position to a second position in the user interface based on the plurality of touch operation positions, and displaying the touch control at the second position.

According to one aspect, this application provides a method for displaying a touch control, the method being executed by a server and including:
receiving an operation record for indicating a plurality of touch operation positions transmitted by a terminal, the plurality of touch operation positions respectively corresponding to a plurality of touch operation instructions, the plurality of touch operation instructions being generated by performing a plurality of touch operations on the touch control;
determining a second position of the touch control in the user interface based on the plurality of touch operation positions, the second position being obtained by adjusting a first position based on the plurality of touch operation positions, the first position being a display position of the touch control in the user interface before position adjustment; and
transmitting second position information for indicating the second position to the terminal to instruct the terminal to display the touch control at the second position.

According to one aspect, this application provides an apparatus for displaying a touch control, including:
a display module configured to display the touch control by using a first position in a user interface as a display position of the touch control; and
a receiving module configured to receive a plurality of touch operation instructions generated by performing a plurality of touch operations on the touch control, and determine a plurality of touch operation positions respectively corresponding to the plurality of touch operation instructions on the user interface,
the display module being further configured to adjust the display position from the first position to a second position in the user interface based on the plurality of touch operation positions, and display the touch control at the second position.

According to one aspect, this application provides an apparatus for displaying a touch control, including:
a receiving module configured to receive an operation record for indicating a plurality of touch operation positions transmitted by a terminal, the plurality of touch operation positions respectively corresponding to a plurality of touch operation instructions, the plurality of touch operation instructions being generated by performing a plurality of touch operations on the touch control;
a determination module configured to determine a second position of the touch control in the user interface based on the plurality of touch operation positions, the second position being obtained by adjusting a first position based on the plurality of touch operation positions, the first position being a display position of the touch control in the user interface before position adjustment; and
a transmission module configured to transmit second position information for indicating the second position to the terminal to instruct the terminal to display the touch control at the second position.

According to another aspect, this application provides a computer device, including: a processor and a memory, the memory having at least one computer program stored therein, the at least one computer program being loaded and executed by the processor to implement the method for displaying the touch control according to any aspect described above.

According to another aspect, this application provides a computer-readable storage medium, the computer-readable storage medium having at least one computer program stored therein, the at least one computer program being loaded and executed by a processor to implement the method for displaying the touch control according to any aspect described above.

According to another aspect, this application provides a computer program product, the computer program product including a computer program, the computer program being stored in a computer-readable storage medium; the computer program being read and executed by a processor of a computer device from the computer-readable storage medium, causing the computer device to implement the method for displaying the touch control according to any aspect described above.

The technical solutions described herein have at least the following beneficial effects.

In the aspects described herein, a plurality of touch operation instructions generated by performing a plurality of touch operations on a touch control are received, touch operation positions respectively corresponding to the plurality of touch operation instructions in a user interface are determined, then a display position of the touch control is adjusted from a first position to a second position based on the plurality of touch operation positions, and finally the touch control is displayed at the second position. In this way, based on the operation positions of the plurality of touch operations triggered by the user on the touch control, a high-frequency click/tap region of the user on the touch control is determined, and then the display position of the touch control is adjusted to the high-frequency click/tap region of the user, thus making the layout position of the touch control more conform to the use habits of the user, improving the convenience in operation, optimizing the layout of the touch control on the user interface, and improving the use efficiency of the touch control. The position of the touch control is adaptively adjusted based on the operation record of the user, and the user does not need to repetitively and manually make adjustments, thus enhancing the convenience in the adjustment of the touch control, improving the user experience, and also improving the adjustment efficiency of the touch control.

### BRIEF DESCRIPTION OF THE DRAWINGS

FIG. 1 is a schematic diagram of an interface in a method for displaying a touch control according to an illustrative aspect described herein.

FIG. 2 is a schematic diagram of an interface in a method for displaying a touch control according to an illustrative aspect described herein.

FIG. 3 is a structural block diagram of a computer system according to an illustrative aspect described herein.

FIG. 4 is a flowchart of a method for displaying a touch control according to an illustrative aspect described herein.

FIG. 5 is a flowchart of a method for displaying a touch control according to an illustrative aspect described herein.

FIG. 6 is a schematic diagram of setting candidate sub-regions according to an illustrative aspect described herein.

FIG. 7 is a flowchart of a method for displaying a touch control according to an illustrative aspect described herein.

FIG. 8 is a flowchart of a method for displaying a touch control according to an illustrative aspect described herein.

FIG. 9 is a flowchart of a method for displaying a touch control according to an illustrative aspect described herein.

FIG. 10 is a schematic diagram of interaction among a user interface layer, a client, and a server in a method for displaying a touch control according to an illustrative aspect described herein.

FIG. 11 is a block diagram of an apparatus for displaying a touch control according to an illustrative aspect described herein.

FIG. 12 is a block diagram of an apparatus for displaying a touch control according to an illustrative aspect described herein.

FIG. 13 is a schematic structural diagram of a computer device according to an illustrative aspect described herein.

FIG. 14 is a schematic structural diagram of a computer device according to an illustrative aspect described herein.

### DESCRIPTION OF ASPECTS

To make the objectives, technical solutions, and advantages described herein clearer, the following further describes implementations described herein in detail with reference to the accompanying drawings.

Firstly, some of the terms used in this application are explained.

Operation hot zone: Operation hot zone refers to a specific region on a screen where a user may perform specific operations, such as clicking/tapping and dragging. The operation hot zone is usually configured for enhancing the interactivity of a user interface and improving the user experience. On a mobile device, the operation hot zone is usually designed as a larger button or gesture region to facilitate the user operation by a single hand.

Button adaptation: Button adaptation refers to the automatic adjustment of button size and layout on screens of different sizes and device types to adapt to different screen sizes and device types to improve the user experience. Button adaptation usually requires corresponding adjustments and layouts based on the size and resolution of the device screen. For example, on small mobile device screens, buttons may need to be reduced and rearranged to fit the limited screen space. On large-screen computers, buttons may need to be enlarged and spaced apart to improve the readability and usability. Button adaptation is an important design principle that can help designers and developers create more flexible user interfaces to improve the user experience and satisfaction.

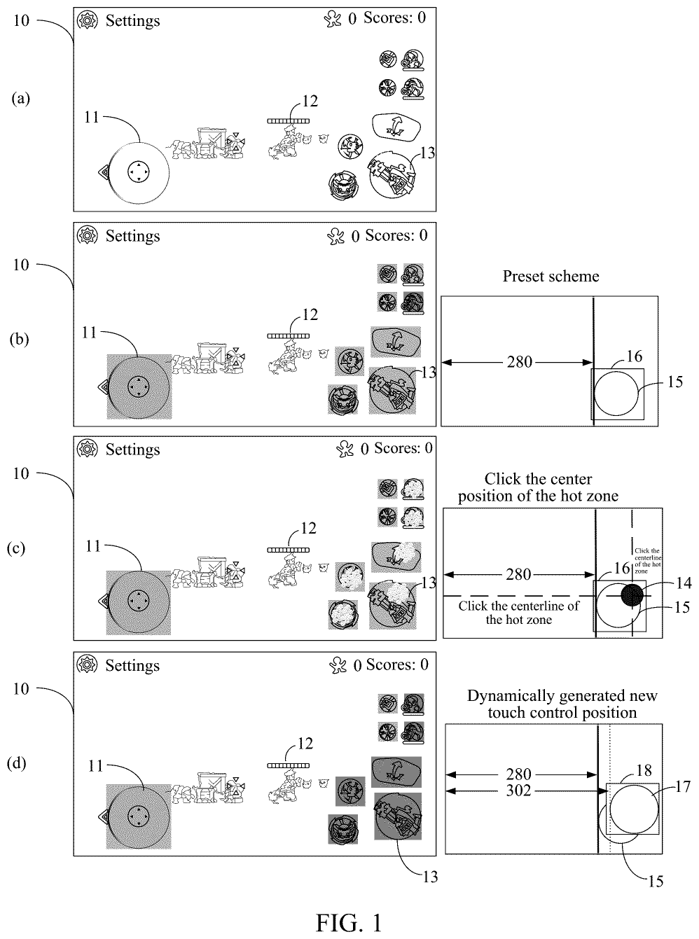

FIG. 1 shows a schematic diagram of a user interface in a method for displaying a touch control according to an illustrative aspect described herein. The method may be executed by a terminal, a client on the terminal, or a server. The schematic diagram takes the client on the terminal being a client of a game application as an example. FIG. 1 takes the user interface being a game application interface and the touch control being a virtual character control in the game application as an example. In practical application, the user interface may also be an interface of any other application, and the touch control may also be a control in any other application, which are not limited in aspects described herein.

Referring to (a) in FIG. 1, a user interface 10 of a game application is displayed in the terminal. The user interface 10 is a default layout interface for touch controls in the system, or a layout interface for touch controls customized by a user. The user interface 10 displays a virtual character 12 and a plurality of touch controls. In this case, each touch control is displayed in its corresponding first position, i.e., a position before adaptive adjustment. For example, a touch control 11 is located on the left, and a touch control 13 is located on the right.

For each touch control on the user interface 10, a predicted region for each touch control is set separately. The predicted region for the touch control covers a display region of the touch control and is larger than the display region of the touch control. The predicted region is configured for recording touch operations on the touch control, that is, touch operations that fall within the predicted region performed on the touch control will be recorded. Referring to the left side of (b) in FIG. 1, a predicted region is set for each touch control on the user interface 10 (the predicted region is represented by a gray rectangle covering the touch control in the figure).

Taking the touch control 13 as an example, a manner of setting its first position and predicted region is shown on the right side of (b) in FIG. 1. A circle 15 represents an abstract schematic shape of the touch control 13 in the user interface 10. In a preset scheme, the leftmost side of the first position of the touch control 13 (i.e., the circle 15 in the figure) is set to be 280 pixels away from the left boundary of the user interface. A predicted region 16 is set for the touch control 13. The predicted region 16 includes the display region of the touch control 13 (i.e., the circle 15 in the figure) and is larger than the display region of the touch control 13.

In the gaming process of the user, a plurality of touch operations performed by the user on the touch control are recorded, that is, a plurality of touch operation instructions generated by performing a plurality of touch operations on the touch control are received, and a second position corresponding to the touch control, i.e., a click/tap hot zone of the user on the touch control, is determined based on touch operation positions respectively corresponding to the plurality of touch operation instructions on the user interface. For example, in (c) in FIG. 1, a plurality of partially overlapping white circles on the touch control 13 represent anchor points of the touch operations of the user on the touch control 13 (i.e., touch operation positions of a plurality of touch operations performed by the user on the touch control 13). A click/tap hot zone is determined based on the plurality of partially overlapping white circles, which is the high-frequency click/tap region of the user on the touch control 13. The right side of (c) in FIG. 1 shows the abstract schematic diagram. A black solid circle 14 represents the second position of the touch control 13 (i.e., the circle 15 in the figure). The position and size of the black solid circle 14 are determined based on the touch operation positions of the plurality of touch operations performed by the user on the touch control 13 (i.e., the plurality of partially overlapping white circles described above). The two dashed lines in the figure represent the centerlines of the second position, that is, the intersection of the two dashed lines is the center of the black solid circle 14 (the center point of the click/tap hot zone).

After the second position of the touch control 13 is determined based on the touch operation positions of the plurality of touch operations performed by the user on the touch control 13, the display position of the touch control 13 is adjusted to the second position, so that the touch control 13 is displayed at the second position. For example, the center of the second position is determined as the center of the touch control 13. The left side of (d) in FIG. 1 shows the touch control 13 after position adjustment, with its center position being the center of the second position. The right side of (d) in FIG. 1 shows the abstract schematic diagram of position adjustment. After adjusting the position of the touch control 13 (i.e., the circle 15 in the figure) based on the second position, it is displayed at the position of a circle 17. The leftmost side of the circle 17 is 302 pixels away from the left boundary of the user interface, and the predicted region is reset based on the new position of the touch control 13, as shown in a rectangular box 18 in the figure.

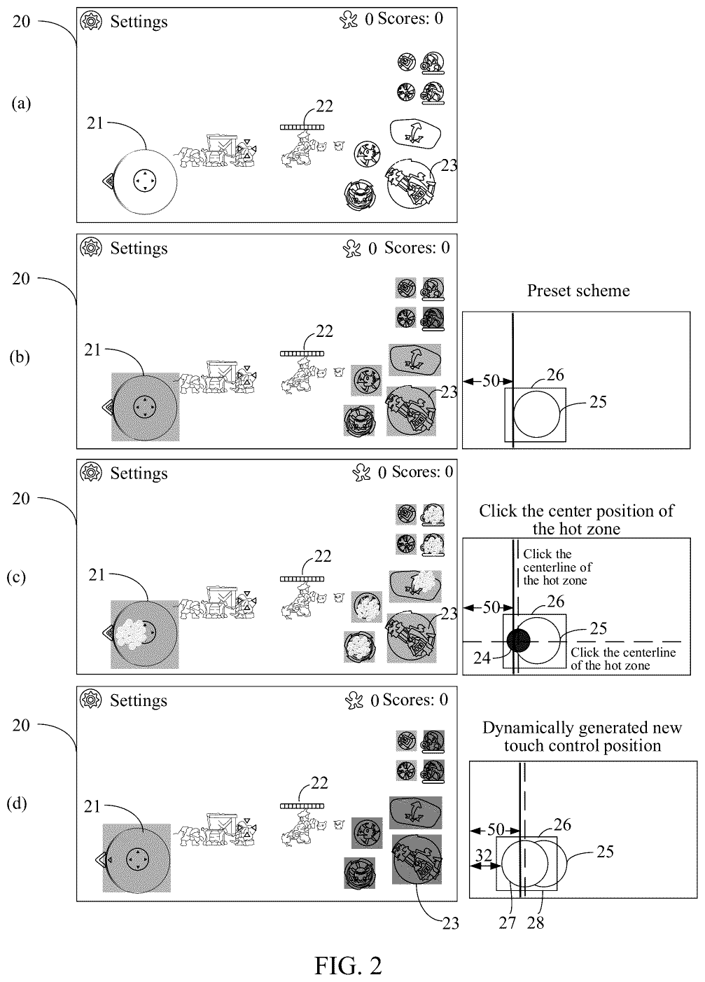

FIG. 2 is a schematic diagram of a user interface in a method for displaying a touch control according to another illustrative aspect described herein. The method may be executed by a terminal, a client on the terminal, or a server. The schematic diagram takes the client on the terminal being a client of a game application as an example. FIG. 2 takes the user interface being a game application interface and the touch control being a virtual character control in the game application as an example. In practical application, the user interface may also be an interface of any other application, and the touch control may also be a control in any other application, which are not limited in aspects described herein.

Referring to (a) in FIG. 2, a user interface 20 of a game application is displayed in the terminal. The user interface 20 is a default layout interface for touch controls in the system, or a layout interface for touch controls customized by a user. The user interface 20 displays a virtual character 22 and a plurality of touch controls. In this case, each touch control is displayed in its corresponding first position, i.e., a position before adaptive adjustment. For example, a touch control 21 is located on the left, and a touch control 23 is located on the right.

For each touch control on the user interface 20, a predicted region for each touch control is set separately. The range of the predicted region for the touch control covers a display region of the touch control and is larger than the display region of the touch control. The predicted region is configured for recording touch operations on the touch control, that is, touch operations that fall within the predicted region performed on the touch control will be recorded. Referring to the left side of (b) in FIG. 2, a predicted region is set for each touch control on the user interface 20 (the predicted region is represented by a gray rectangle covering the touch control in the figure).

Taking the touch control 21 as an example, a manner of setting its initial position and predicted region is shown on the right side of (b) in FIG. 2. A circle 25 represents an abstract schematic shape of the touch control 21 in the user interface. In a preset scheme, the leftmost side of the first position of the touch control 21 (i.e., the circle 25 in the figure) is set to be 50 pixels away from the left boundary of the user interface. A predicted region 26 is set for the touch control 21. The predicted region 26 includes the display region of the touch control 21 (i.e., the circle 25 in the figure) and is larger than the display region of the touch control 21.

In the gaming process of the user, a plurality of touch operations performed by the user on the touch control are recorded, that is, a plurality of touch operation instructions generated by performing a plurality of touch operations on the touch control are received, and a second position corresponding to the touch control, i.e., a click/tap hot zone of the user on the touch control, is determined based on touch operation positions respectively corresponding to the plurality of touch operation instructions on the user interface. For example, in (c) in FIG. 2, a plurality of partially overlapping white circles on the touch control 21 represent anchor points of the touch operations of the user on the touch control 21 (i.e., touch operation positions of a plurality of touch operations performed by the user on the touch control 21). A click/tap hot zone is determined based on the plurality of partially overlapping white circles, which is the high-frequency click/tap region of the user on the touch control 21. The right side of (c) in FIG. 2 shows the abstract schematic diagram. A black solid circle 24 represents the second position of the touch control 21 (i.e., the circle 25 in the figure). The position and size of the black solid circle 24 are determined based on the touch operation positions of the plurality of touch operations performed by the user on the touch control 21 (i.e., the plurality of partially overlapping white circles described above). The two dashed lines in the figure represent the centerlines of the second position, that is, the intersection of the two dashed lines is the center of the black solid circle 24 (the center point of the click/tap hot zone).

After the second position of the touch control 21 is determined based on the touch operation positions of the plurality of touch operations performed by the user on the touch control 21, the display position of the touch control 21 is adjusted to the second position, so that the touch control 21 is displayed at the second position. For example, the center of the second position is determined as the center of the touch control 21. The left side of (d) in FIG. 2 shows the touch control 21 after position adjustment, with its center position being the center of the second position. The right side of (d) in FIG. 2 shows the abstract schematic diagram of position adjustment. After adjusting the position of the touch control 21 (i.e., the circle 25 in the figure) based on the second position, it is displayed at the position of a circle 27. The leftmost side of the circle 27 is 32 pixels away from the left boundary of the user interface, and the predicted region is reset based on the new position of the touch control 21, as shown in a rectangular box 28 in the figure.

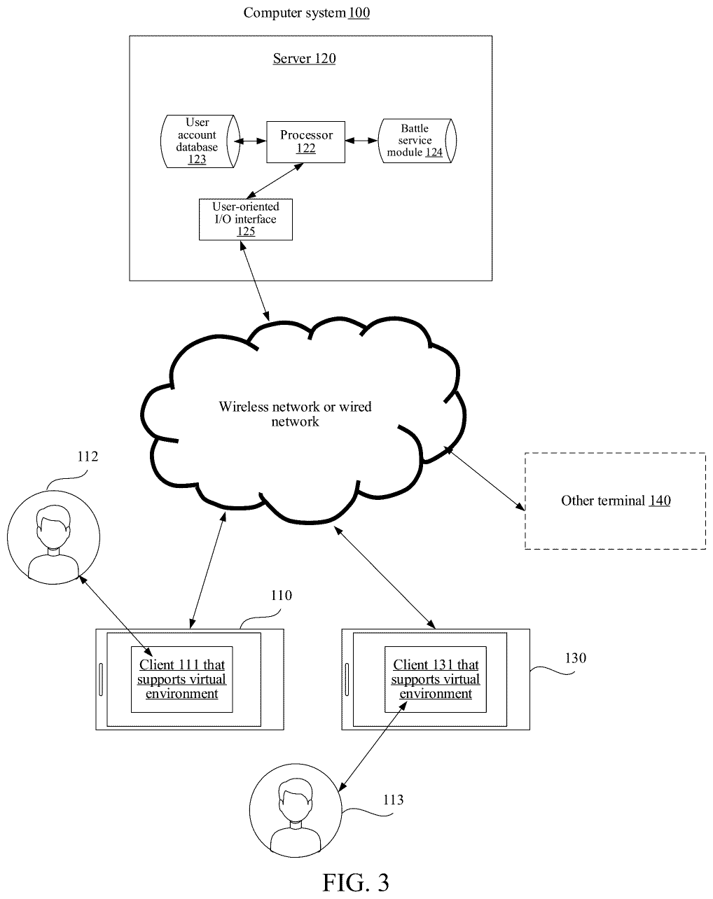

FIG. 3 shows a structural block diagram of a computer system according to an illustrative aspect described herein. The computer system 100 includes a first terminal 110, a server 120, and a second terminal 130.

A client 111 that supports a virtual environment is installed and run on the terminal 110. The client 111 may be a multiplayer online battle program. When the first terminal 110 runs the client 111, a user interface of the client 111 is displayed on a screen of the first terminal 110. The client 111 may be any one of applications such as a battle royale shooting game, a Virtual Reality (VR) application program, an Augmented Reality (AR) program, a three-dimensional map program, a virtual reality game, an augmented reality game, a First-Person Shooting game (FPS), a Third-Person Shooting game (TPS), a Multiplayer Online Battle Arena game (MOBA), and a Simulation Game (SLG). In this aspect, description is made by taking the client 111 being an MOBA game as an example. The first terminal 110 is a terminal used by a first user 112. The first user 112 uses the first terminal 110 to control the activities of a first virtual character located in the virtual environment. For example, it controls a pet virtual character to explore in the virtual world. The first virtual character may be referred to as a virtual character of the first user 112. The first user 112 may perform operations such as assembling, disassembling, and unloading virtual items owned by the first virtual character, which is not limited in this application. Illustratively, the first virtual character may be a simulated character or a cartoon character, for example.

A client 131 that supports a virtual environment is installed and run on the second terminal 130. The client 131 may be a multiplayer online battle program. When the second terminal 130 runs the client 131, a user interface of the client 131 is displayed on a screen of the second terminal 130. The client may be any one of applications such as a battle royale shooting game, a VR application, an AR program, a three-dimensional map program, a virtual reality game, an augmented reality game, an FPS, a TPS, an MOBA, and an SLG. In this aspect, description is made by taking the client 131 being an MOBA game as an example. The second terminal 130 is a terminal used by a second user 113. The second user 113 uses the second terminal 130 to control the activities of a second virtual character located in the virtual environment. For example, it controls a pet virtual character to explore in the virtual world. The second virtual character may be referred to as a virtual character of the second user 113. Illustratively, the second virtual character may be a simulated character or a cartoon character, for example.

In some aspects, the first virtual character and the second virtual character may be in the same virtual environment. In some aspects, the first virtual character and the second virtual character may belong to the same camp, the same team, or the same organization, have a friend relationship, or have a temporary communication permission. In some aspects, the first virtual character and the second virtual character may belong to different camps, different teams, or different organizations, or have an adversarial relationship.

In some aspects, the clients installed on the first terminal 110 and the second terminal 130 are the same, or the clients installed on the two terminals are clients of the same type on different operating system platforms (Android or IOS). The first terminal 110 may generally be one of a plurality of terminals, and the second terminal 130 may generally be another one of the plurality of terminals. In this aspect, description is made by taking only the first terminal 110 and the second terminal 130 as an example. The device type of the first terminal 110 and the second terminal 130 may be the same or different. The device type includes, but is not limited to, at least one of a smart phone, a tablet computer, an e-book reader, a Moving Picture Experts Group Audio Layer III (MP3) player, a Moving Picture Experts Group Audio Layer IV (MP4) player, a portable laptop computer, and a desktop computer.

FIG. 3 only shows two terminals. However, in different aspects, there may be a plurality of other terminals 140 that can access the server 120. In some aspects, there may be one or more terminals 140 that correspond to a developer. A development and editing platform for a client that supports a virtual environment is installed on the terminal 140. The developer may edit and update the client on the terminal 140, and transmit an updated client installation package to the server 120 through a wired or wireless network. The first terminal 110 and the second terminal 130 may download the client installation package from the server 120 to update the client.

The first terminal 110, the second terminal 130, and the other terminal 140 are connected to the server 120 through a wireless network or a wired network.

The server 120 includes at least one of one server, a plurality of servers, a cloud computing platform, and a virtualization center. The server 120 is configured to provide a backend service for the client that supports the virtual environment. In some aspects, the server 120 is responsible for primary computing work, and the terminals are responsible for secondary computing work. Alternatively, the server 120 is responsible for secondary computing work, and the terminals are responsible for primary computing work. Alternatively, a distributed computing architecture may be used between the server 120 and the terminals for collaborative computing.

In an example, the server 120 includes a processor 122, a user account database 123, a battle service module 124, and a user-oriented input/output interface (I/O interface) 125. The processor 122 is configured to load an instruction stored in the server 120 and process data in the user account database 123 and the battle service module 124. The user account database 123 is configured to store data of user accounts logged in by the first terminal 110, the second terminal 130, and the other terminal 140, such as avatars of the user accounts, nicknames of the user accounts, battle strength indexes of the user accounts, and service areas of the user accounts. The battle service module 124 is configured to provide a plurality of battle rooms for users to battle, for example, 1V1 battles, 3V3 battles, and 5V5 battles. The user-oriented I/O interface 125 is configured to establish communication with the first terminal 110 and/or the second terminal 130 through a wireless network or a wired network to exchange data.

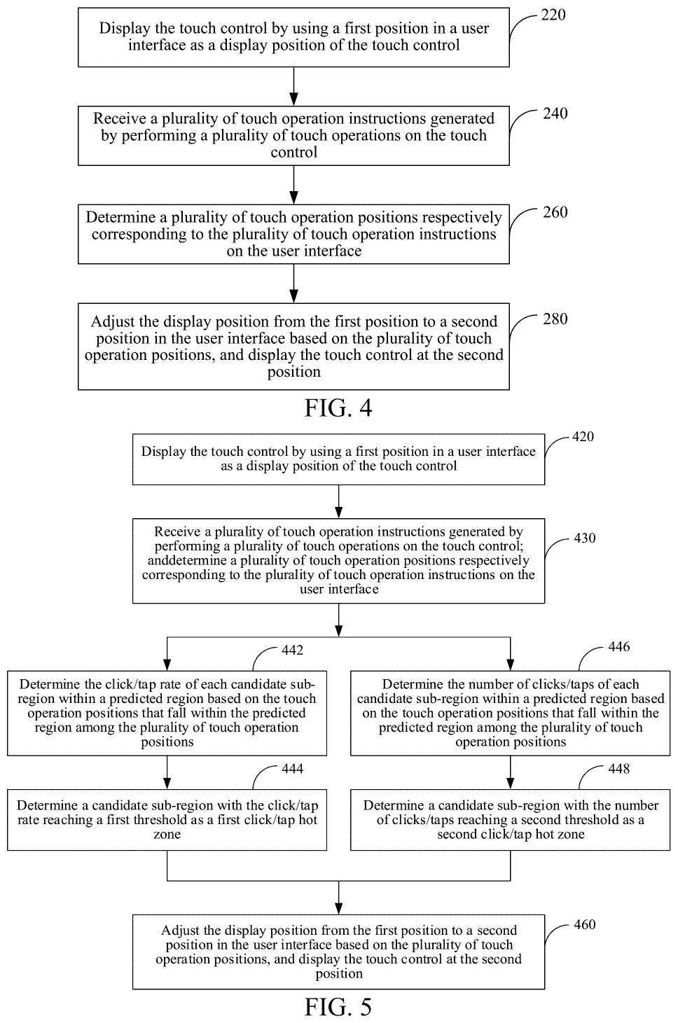

FIG. 4 is a flowchart of a method for displaying a touch control according to an illustrative aspect described herein. The method may be executed by the terminal or the client on the terminal in the system shown in FIG. 3. The method includes the following operations:
Operation 220: Display the touch control by using a first position in a user interface as a display position of the touch control.

The user interface is an interface for interaction between a user and the terminal or the client on the terminal. Taking the game application program running on the terminal as an example, the user interface includes virtual characters, touch controls, and so on. The virtual characters are configured for completing activities in the virtual world provided by the game application under the control of users, and the touch controls are configured for supporting the users in controlling the virtual characters. The user interface is preset with a hot zone. The hot zone is a touch region for performing control operations on the virtual characters. The hot zone may also be understood as a region for responding to touch operations on the touch controls.

The first position refers to a position where the touch control is located before position adjustment. For example, on the initial interface at the beginning of the game, the first position where the touch control is located is determined based on the layout preset in the system. Alternatively, in a case that the user customizes the layout of the touch control on the user interface, the first position where the touch control is located is determined based on the custom layout.

Illustratively, the first position of the touch control is determined based on the default settings of the system or the custom settings of the user. The touch control is displayed at the first position in the user interface.

In some aspects, in order to adapt the display of the touch control to user interfaces of different sizes or resolutions, it is necessary to adjust the size or layout of the touch control based on the size or resolution of the user interface. For example, the size of the touch control is adjusted based on the size and/or resolution of the user interface.

Illustratively, the size ratio of the user interface to a preset interface is determined based on the size and/or resolution of the user interface. The size of the touch control is adjusted based on the ratio. The preset interface here is a display mode of the user interface set during application development. For example, the ratio of the height of the user interface to the height of the preset interface is calculated, and the touch control is scaled up or down proportionally based on the ratio. Alternatively, the touch control is scaled down on the terminal with the user interface which is small, and is rearranged, which is not limited in this application. In this way, the size of the touch control is adjusted based on the size and/or resolution of the user interface, so that the display of the touch control can adapt to user interfaces of different sizes and/or resolutions, thus making it easier for users to trigger operations more accurately through the touch control, and improving the user experience.
Operation 240: Receive a plurality of touch operation instructions generated by performing a plurality of touch operations on the touch control.
Operation 260: Determine a plurality of touch operation positions respectively corresponding to the plurality of touch operation instructions on the user interface.

The touch operations refer to operations triggered on the touch control, and may be at least one of click/tap operations, long press operations, drag operations, double-click/tap operations, voice operations, pressure touch operations, eye gaze controls, and motion sensing control, which are not limited in this application. The touch operation instructions are computer instructions generated by the terminal in response to the touch operations triggered by the user, and the terminal needs to perform related operations based on the touch operation instructions. The touch operation instructions may indicate the control positions of the corresponding touch operations in the user interface, i.e., the touch operation positions.

The touch operations on the touch control refer to that a target object of the touch operations is the touch control, but the touch operations may not necessarily fall accurately on the touch control. That is, the touch operations on the touch control include touch operations that fall onto the touch control and touch operations that fall around the touch control.

In some aspects, a predicted region for the touch control is set. The predicted region is a predicted region where the touch operations on the touch control may fall. The predicted region is a region in the user interface that includes at least one part or the entire part of the touch control and has an area larger than the area of the touch control. In this aspect described herein, any touch operations that fall within the predicted region for the touch control are considered as touch operations on the touch control, and the positions of the touch operations in the predicted region will be recorded accordingly to provide reference for adjusting the display position of the touch control in the future. That is to say, the plurality of touch operations on the touch control described above are all touch operations that fall within the predicted region for the touch control. In some aspects, the predicted region does not cover the regions of other touch controls. In practical application, the touch operations triggered by the user on the touch control may fall onto positions outside the touch control in the predicted region. When a plurality of touch operations triggered by the user on the touch control fall onto positions outside the touch control in the predicted region, it may be considered that the display position of the touch control does not conform to the operating habits of the user. In this case, the display position of the touch control may be adjusted based on touch operation positions of the plurality of touch operations triggered by the user on the touch control, so that the adjusted position conforms to the operating habits of the user.

In practical application, the touch operations that fall onto positions outside the touch control in the predicted region may be statistically counted within a preset time period (such as one day, two days, or one week) based on all the touch operations performed by the user on a certain touch control, for example, by counting the number of touch operations that fall onto positions outside the touch control, or counting the proportion of touch operations that fall outside the touch control in all the touch operations. Then, by comparing the relationship between a statistical result and a preset threshold, if the statistical result is higher than the preset threshold, it indicates that more of the touch operations triggered by the user on the touch control fall onto positions outside the touch control. In this case, the display position of the touch control may be adjusted based on these touch operation positions.

Illustratively, after a plurality of touch operations on the touch control are received, the terminal determines an adjusted second position of the touch control based on the operation position of the plurality of touch operations; alternatively, after receiving a plurality of touch operations on the touch control, the terminal transmits an operation record of the plurality of touch operations to the server, and receives second position information transmitted by the server after the server determines the adjusted second position of the touch control. The second position information is configured for indicating the second position of the touch control.
Operation 280: Adjust the display position from the first position to a second position in the user interface based on the plurality of touch operation positions, and display the touch control at the second position.

The second position is obtained by adjusting the first position based on the plurality of touch operation positions. Compared with the first position, the second position more conforms to the operating habits of the user, that is, the touch operations performed by the user on the touch control are more likely to fall onto the second position and its surroundings.

Illustratively, the terminal displays the position-adjusted touch control at the second position in the user interface.

In some aspects, the second position is determined based on the first click/tap hot zone, and it may be the center position of the first click/tap hot zone, for example; the first click/tap hot zone is a region with the click/tap rate reaching a first threshold, the click/tap rate of the first click/tap hot zone is determined based on the number of the touch operation positions that fall within the first click/tap hot zone among the multiple touch operation positions, and the first threshold is a preset click/tap rate threshold.

In some aspects, the second position is determined by the terminal. The terminal determines the click/tap rate of each candidate sub-region within a predicted region based on the touch operation positions that fall within a predicted region among the multiple touch operation positions. The predicted region is a region that includes the touch control and has an area larger than the area of the touch control in the user interface. A candidate sub-region with the click/tap rate reaching the first threshold is determined as the first click/tap hot zone.

In some aspects, the second position is determined by the server. The terminal transmits an operation record for indicating the plurality of touch operation positions to the server. After the server determines the second position, the terminal receives second position information transmitted by the server. The second position information is configured for indicating the second position. The second position information is determined by the server based on the operation record. The server is configured to determine the click/tap rate of each candidate sub-region within a predicted region based on the touch operation positions that fall within the predicted region among the multiple touch operation positions, and determine a candidate sub-region with the click/tap rate reaching the first threshold as the first click/tap hot zone.

In some other aspects, the second position is determined based on a second click/tap hot zone, and may be the center position of the second click/tap hot zone, for example. The second click/tap hot zone is a region with the number of clicks/taps reaching a second threshold. The number of clicks/taps of the second click/tap hot zone is the number of touch operation positions that fall within the second click/tap hot zone among the multiple touch operation positions. The second threshold is a preset number-of-clicks/taps threshold.

In some aspects, the second position is determined by the terminal. The number of clicks/taps of each candidate sub-region within a predicted region is determined based on the touch operation positions that fall within a predicted region among the multiple touch operation positions. The predicted region is a region that includes the touch control and has an area larger than the area of the touch control in the user interface. A candidate sub-region with the number of clicks/taps reaching the second threshold is determined as the second click/tap hot zone.

In some aspects, the second position is determined by the server. The terminal transmits an operation record for indicating the plurality of touch operation positions to the server. After the server determines the second position, the terminal receives second position information transmitted by the server. The second position information is configured for indicating the second position. The second position information is determined by the server based on the operation record. The server is configured to determine the number of clicks/taps of each candidate sub-region within a predicted region based on the touch operation positions that fall within the predicted region among the multiple touch operation positions, and determine a candidate sub-region with the number of clicks/taps reaching the second threshold as the second click/tap hot zone.

In other aspects, the second position is the center position of the circumscribed circle or circumscribed regular polygon of a plurality of third click/tap hot zones. The plurality of third click/tap hot zones are regions with the click/tap rate and/or number of clicks/taps reaching a threshold in a plurality of grid regions. The plurality of grid regions are obtained by dividing the predicted region into grids.

In some aspects, the second position information received by the terminal is the coordinates of the second position; alternatively, the second position information is the offset data of the second position relative to the first position.

To sum up, in the method provided in this aspect, a plurality of touch operation instructions generated by performing a plurality of touch operations on a certain touch control are received, touch operation positions respectively corresponding to the plurality of touch operation instructions in a user interface are determined, then a display position of the touch control is adjusted from a first position to a second position based on the plurality of touch operation positions, and finally the touch control is displayed at the second position. In this way, based on the operation positions of the plurality of touch operations triggered by the user on the touch control, a high-frequency click/tap region of the user on the touch control is determined, and then the display position of the touch control is adjusted to the high-frequency click/tap region of the user, thus making the layout position of the touch control more conform to the use habits of the user, improving the convenience in operation, optimizing the layout of the touch control on the user interface, and improving the use efficiency of the touch control. The position of the touch control is adaptively adjusted based on the operation record of the user, and the user does not need to repetitively and manually make adjustments, thus enhancing the convenience in the adjustment of the touch control, improving the user experience, and also improving the adjustment efficiency of the touch control.

FIG. 5 is a flowchart of a method for displaying a touch control according to an illustrative aspect described herein. The method may be executed by the terminal or the client on the terminal in the system shown in FIG. 3. The method includes the following operations:
Operation 420: Display the touch control by using a first position in a user interface as a display position of the touch control.

The user interface is an interface for interaction between a user and the terminal or the client on the terminal.

The first position refers to a position where the touch control is located before position adjustment. For example, on the initial interface at the beginning of the game, the first position where the touch control is located is determined based on the layout preset in the system. Alternatively, in a case that the user customizes the layout of the touch control on the user interface, the first position where the touch control is located is determined based on the custom layout.

Illustratively, the first position of the touch control is determined based on the default settings of the system or the custom settings of the user. The touch control is displayed at the first position in the user interface.
Operation 430: Receive a plurality of touch operation instructions generated by performing a plurality of touch operations on the touch control; and determine a plurality of touch operation positions respectively corresponding to the plurality of touch operation instructions on the user interface.

The touch operations refer to operations triggered on the touch control, and may be at least one of click/tap operations, long press operations, drag operations, double-click/tap operations, voice operations, pressure touch operations, eye gaze controls, and motion sensing control, which are not limited in this application. The touch operation instructions are computer instructions generated by the terminal in response to the touch operations triggered by the user, and the terminal needs to perform related operations based on the touch operation instructions. The touch operation instructions may indicate the control positions of the corresponding touch operations in the user interface, i.e., the touch operation positions.

The touch operations on the touch control refer to that a target object of the touch operations is the touch control, but the touch operations may not necessarily fall accurately on the touch control. That is, the touch operations on the touch control include touch operations that fall onto the touch control and touch operations that fall around the touch control.

Illustratively, the terminal receives a plurality of touch operations on the touch control.

In some aspects, a predicted region for the touch control is set. The predicted region is a predicted operation region where the touch operations on the touch control may fall. In this aspect described herein, any touch operations that fall within the predicted region for the touch control are considered as operations on the touch control and will be recorded accordingly to provide reference for adjusting the display position of the touch control in the future, that is, the plurality of touch operations on the touch control described above are all touch operations that fall within the predicted region for the touch control, and the predicted region is a region which includes the touch control and is larger than the touch control. In some aspects, the predicted region does not cover the regions of other touch controls.

In order to record the distribution of the plurality of touch operations within the predicted region, i.e., how many touch operations there are at different positions in the predicted region, it is necessary to divide the predicted region into a plurality of candidate sub-regions. A manner of setting the candidate sub-regions includes any one of: dividing the predicted region into a plurality of rectangular candidate sub-regions that do not overlap with each other, for example, dividing the predicted region into a plurality of rectangular candidate sub-regions that do not overlap with each other according to a grid pattern; dividing the predicted region into a plurality of sector-shaped candidate sub-regions that do not overlap with each other, for example, dividing the predicted region into a plurality of sector-shaped candidate sub-regions that do not overlap with each other and correspond to a preset sector angle according to the preset sector angle; setting a plurality of circular candidate sub-regions that have the same radius and partially overlap with each other in the predicted region by taking a center of the predicted region as a reference position; setting a plurality of circular candidate sub-regions that have the same radius and partially overlap with each other in the predicted region by taking a center of the touch control as a reference position; and setting a plurality of circular candidate sub-regions that have the same radius in the predicted region by taking the operation position of each touch operation as a center.

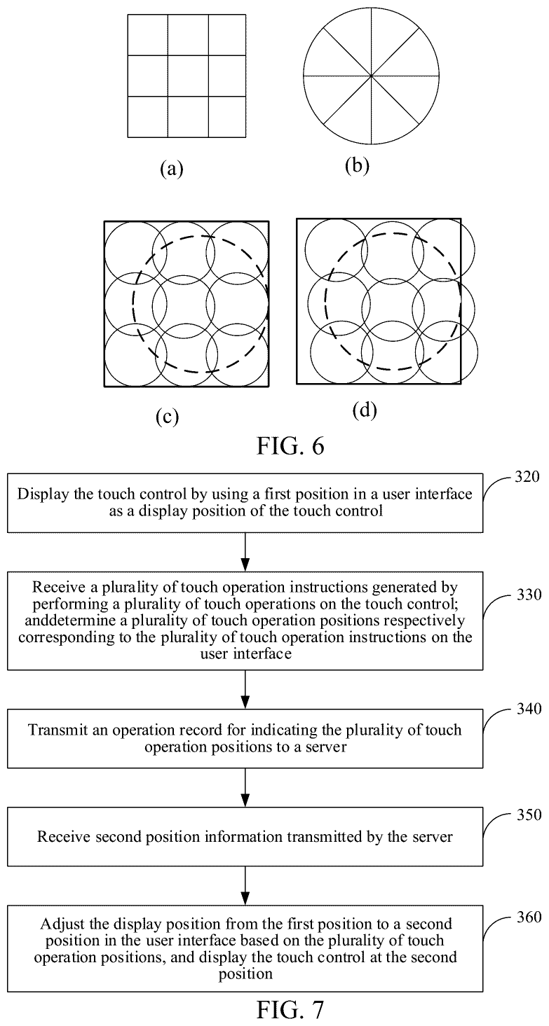

FIG. 6 shows a schematic diagram of a plurality of candidate sub-regions set in the predicted region. In (a), taking the predicted region being rectangular as an example, the predicted region is divided into a plurality of rectangular candidate sub-regions that do not overlap with each other by adopting a grid pattern dividing manner. In (b), taking the predicted region being circular as an example, the predicted region is divided into a plurality of sector-shaped candidate sub-regions that do not overlap with each other by adopting a sector dividing manner. In (c), the dashed circle indicates the touch control, the rectangular box indicates the predicted region, and the solid circles indicate the candidate sub-regions. A plurality of circular candidate sub-regions that have the same radius and partially overlap with each other are set in the predicted region by taking a center of the predicted region (i.e., the rectangular box) as a reference position. In (d), the dashed circle indicates the touch control, the rectangular box indicates the predicted region, and the solid circles indicate the candidate sub-regions. A plurality of circular candidate sub-regions that have the same radius and partially overlap with each other are set in the predicted region by taking a center of the touch control (i.e., the dashed circle) as a reference position. If the set candidate sub-regions exceed the predicted region, only valid operation records falling within the predicted region will be statistically counted, and invalid operation records outside the predicted region will be ignored.

In addition, manners (a) and (b) in FIG. 6 may also be implemented as partially overlapping candidate sub-regions, while manners (c) and (d) may also be implemented as non-overlapping candidate sub-regions, which is not limited in this application.

In addition to the manners of setting the candidate sub-regions shown in FIG. 6, candidate sub-regions may also be dynamically set based on the touch operations of the user. For example, a plurality of circular candidate sub-regions that have the same radius or a plurality of rectangular candidate sub-regions that have the same size are set in the predicted region by taking the operation position of each touch operation as a center.

Through the manners of setting the candidate sub-regions described above, it can be ensured that the set candidate sub-regions reasonably cover the predicted region, thus more accurately determining the distribution of the touch operations that fall within the predicted region among the plurality of touch operations in the predicted region, that is, how many touch operations there are at different positions in the predicted region, which is conducive to determining the display position of the touch control that more conforms to the operating habits of the user accordingly.

Only one of operation 442 to operation 444 and operation 446 to operation 448 below needs to be performed. Operation 442 to operation 444 are performed in a case that the second position is determined based on the click/tap rate, and operation 446 to operation 448 are performed in a case that the second position is determined based on the number of clicks/taps.
Operation 442: Determine the click/tap rate of each candidate sub-region within a predicted region based on the touch operation positions that fall within the predicted region among the plurality of touch operation positions.

Illustratively, the number of clicks/taps of each candidate sub-region, i.e., the number of touch operations that fall within each candidate sub-region, is statistically counted based on the touch operation positions that fall within the predicted region among the plurality of touch operation positions. The click/tap rate of each candidate sub-region is determined based on the number of clicks/taps of each candidate sub-region and the total number of touch operations.

The number of clicks/taps is the number of clicks/taps statistically counted within a time length L. For example, the number of clicks/taps in the operation record is statistically counted every time length L; alternatively, a sliding window with a size of time length L is set, and statistical counting of the number of clicks/taps is performed on the operation records in the sliding window.

Illustratively, the click/tap rate of each candidate sub-region is obtained by dividing the number of clicks/taps of each candidate sub-region by the total number of clicks/taps that fall within the predicted region.
Operation 444: Determine a candidate sub-region with the click/tap rate reaching a first threshold as a first click/tap hot zone.

The first threshold is a preset click/tap rate threshold; alternatively, the first threshold is a dynamically adjusted click/tap rate threshold. For example, the first threshold is preset to 50%; alternatively, the click/tap rates of all candidate sub-regions are sorted from high to low, and the click/tap rate ranked the third is determined as the first threshold, and so on, which is not limited in this application.

Illustratively, a candidate sub-region with the click/tap rate reaching the first threshold is determined as the first click/tap hot zone, i.e., the high-frequency click/tap region of the user on the touch control.

In some aspects, in a case that there are a plurality of candidate sub-regions with the click/tap rates reaching the first threshold and they are not adjacent, the candidate sub-regions with the click/tap rate reaching the first threshold are sorted according to the click/tap rates from high to low, and the adjacent candidate sub-regions of the first n candidate sub-regions are determined as the first click/tap hot zone, where n is a natural number.

In some aspects, the candidate sub-regions with the click/tap rates reaching the first threshold are sorted according to the click/tap rates from high to low, and the first n candidate sub-regions are determined as the first click/tap hot zone, where n is a natural number.

That is, the click/tap rate of each candidate sub-region in the predicted region is determined according to operation 442, then the first click/tap hot zone is determined based on the click/tap rate in this operation, and finally the touch control is displayed at the second position determined based on the first click/tap hot zone in operation 460 below. In this way, determining the first click/tap hot zone based on the click/tap rate can ensure that the determined first click/tap hot zone is a region frequently clicked/tapped by the user when triggering touch operations on the control. Correspondingly, determining the second position based on the first click/tap hot zone and adjusting the display position of the control to the second position can ensure that the adjusted control more conforms to the operating habits of the user.
Operation 446: Determine the number of clicks/taps of each candidate sub-region within a predicted region based on the touch operation positions that fall within the predicted region among the plurality of touch operation positions.

Illustratively, the number of clicks/taps of each candidate sub-region is statistically counted based on the touch operation positions that fall within the predicted region among the plurality of touch operation positions.

The number of clicks/taps is the number of clicks/taps statistically counted within a time length L. For example, the number of clicks/taps in the operation record is statistically counted every time length L; alternatively, a sliding window with a size of time length L is set, and statistical counting of the number of clicks/taps is performed on the operation records in the sliding window.
Operation 448: Determine a candidate sub-region with the number of clicks/taps reaching a second threshold as a second click/tap hot zone.

The second threshold is a preset number-of-click/tap threshold; alternatively, the second threshold is a dynamically adjusted number-of-click/tap threshold. For example, the second threshold is preset to 10; alternatively, the number of clicks/taps of all candidate sub-regions are stored from high to low, and the number of clicks/taps ranked the third is determined as the second threshold, and so on, which is not limited in this application.

Illustratively, a candidate sub-region with the number of clicks/taps reaching the second threshold is determined as the second click/tap hot zone, i.e., the high-frequency click/tap region of the user on the touch control.

In some aspects, in a case that there are a plurality of candidate sub-regions with the number of clicks/taps reaching the second threshold and they are not adjacent, the candidate sub-regions with the number of clicks/taps reaching the second threshold are sorted according to the number of clicks/taps from high to low, and the adjacent candidate sub-regions of the first n candidate sub-regions are determined as the second click/tap hot zone, where n is a natural number.

In some aspects, the candidate sub-regions with the number of clicks/taps reaching the second threshold are sorted according to the number of clicks/taps from high to low, and the first n candidate sub-regions are determined as the second click/tap hot zone, where n is a natural number.

That is, the number of clicks/taps of each candidate sub-region in the predicted region is determined according to operation 446, then the second click/tap hot zone is determined based on the number of clicks/taps in this operation, and finally the touch control is displayed at the second position determined based on the second click/tap hot zone in operation 460 below. In this way, statistically counting the number of clicks/taps of each candidate sub-region in the predicted region and determining the second click/tap hot zone based on the number of clicks/taps can ensure that the determined second click/tap hot zone is a region frequently clicked/tapped by the user when triggering touch operations on the touch control. Correspondingly, determining the second position based on the second click/tap hot zone and adjusting the display position of the touch control to the second position can ensure that the adjusted touch control more conforms to the operating habits of the user.
Operation 460: Adjust the display position from the first position to a second position in the user interface based on the plurality of touch operation positions, and display the touch control at the second position.

In a case that the second position is determined based on the click/tap rate, that is, in a case that operation 442 to operation 444 are performed, the second position may be the center position of the first click/tap hot zone. In a case that the second position is determined based on the number of clicks/taps, that is, in a case that operation 446 to operation 448 are performed, the second position may be the center position of the second click/tap hot zone.

Illustratively, the terminal displays the touch control at the second position in the user interface.

In some aspects, in a case that the number of invalid operations that fall within the predicted region but do not fall onto the touch control among the plurality of touch operations exceeds a first invalidity threshold within a first time threshold, the process of determining the second position is triggered. The first time threshold is a preset time threshold, and the first invalidity threshold is a preset number-of-click/tap threshold. That is, if the operation positions of the touch operations of the user frequently fall around the touch control within a certain time period, adaptive position adjustment of the touch control is initiated.

In some aspects, in a case that the distance between the center position of the plurality of touch operation positions and the center position of the touch control is greater than a second invalidity threshold within a second time threshold, the process of determining the second position described above is triggered. The second time threshold is a preset time threshold, and the second invalidity threshold is a preset distance threshold. That is, if the high-frequency operation region of the touch operations of the user is far from the center of the touch control within a certain time period, adaptive position adjustment of the touch control is initiated.

In this way, through the above determination mechanism, the display position of the touch control is adjusted in a timely manner based on the operating habits of the user, so that the display position of the touch control quickly adapts to the operating habits of the user.

In addition to adjusting the position of the touch control described above, the size of the touch control may also be adjusted.

In some aspects, the size of the touch control is adjusted based on the size and/or resolution of the user interface. For example, the size ratio of the user interface to a preset interface is determined based on the size and/or resolution of the user interface. The size of the touch control is adjusted based on the ratio. The preset interface may be, for example, a template interface set for the user interface during application development.

In some aspects, the size of the touch control is adjusted based on the distance between the touch control and an adjacent touch control. For example, in a case that the distance between the touch control and an adjacent touch control is less than a distance threshold, the touch control is scaled down. In a case that the distance between the touch control and an adjacent touch control is greater than a distance threshold, the touch control is scaled up.

In some aspects, the size of the touch control is adjusted based on the operation positions of the plurality of touch operations; alternatively, the size of the touch control is adjusted based on the operation positions of invalid operations that fall outside the touch control but belong to the predicted region among the plurality of touch operations.

For example, the size of the touch control is adjusted based on the size of a click/tap hot zone. The click/tap hot zone is a region with the click/tap rate and/or the number of clicks/taps reaching a click/tap threshold. The click/tap rate is determined based on the number of touch operations that fall within the click/tap hot zone among the plurality of touch operations. The click/tap hot zone may be specifically the first click/tap hot zone or the second click/tap hot zone described above. In some aspects, the size of the click/tap hot zone is used as the size of the touch control; alternatively, the size of the smallest circle including the click/tap hot zone is determined as the size of the touch control; alternatively, the size of the smallest rectangle including the click/tap hot zone is determined as the size of the touch control; alternatively, in a case that the size of the click/tap hot zone is much smaller than the size of the touch control, the size of the touch control is scaled down; further alternatively, in a case that the size of the click/tap hot zone is similar to the size of the touch control, the size of the touch control is appropriately scaled up, and so on.

For another example, the size of the touch control is adjusted based on the operation positions of invalid operations that fall within the predicted region but do not fall onto the touch control. For example, the size of the touch control is appropriately scaled up based on the distribution of the invalid operations, so as to ensure that as many touch operations as possible fall within the valid region without affecting other touch controls.

In this way, by adjusting the size of the touch control based on the size and/or resolution of the user interface, the distance between the touch control and an adjacent touch control, or the operating positions of a plurality of touch operations, the size of the touch control can be adapted to the user interface and/or the operating habits of the user, thus making it more convenient for the user to trigger accurate operations on the touch control.

In some aspects, after adjusting the size of the touch control based on the operation positions of the plurality of touch operations, the click/tap threshold (such as the first threshold or second threshold described above) for measuring the click/tap hot zone is adjusted based on the distance between the touch control and an adjacent touch control. For example, in a case that the distance between the touch control with the size adjusted and an adjacent touch control is less than the distance threshold, the click/tap threshold is increased. In a case that the distance between the touch control with the size adjusted and an adjacent touch control is greater than the distance threshold, the click/tap threshold is decreased. In this way, by adjusting the click/tap threshold, the adjustment of the display position of the touch control is restricted, thus preventing frequent adjustment of the display position of the touch control from affecting the use of another adjacent touch control.

In addition to adjusting the size of the touch control, transparency adjustment and other manners may also be used to ensure that the touch control displayed at the second position does not block the virtual character in the user interface. The virtual character is a character in a three-dimensional virtual world. When determining the display position of the virtual character in the user interface, it is necessary to map the model of the virtual character to the imaging plane of a two-dimensional virtual image, and then compute the intersection with the display region of the touch control to determine whether blocking has occurred.

In some aspects, in a case that the touch control blocks the virtual character in the user interface, the touch control is scaled down; alternatively, in a case that the touch control blocks the virtual character in the user interface, the touch control is displayed semi-transparently; alternatively, in a case that the touch control blocks the virtual character in the user interface, only the outline of the touch control is displayed.

In some aspects, in a case that the touch control is scaled down to its minimum size but still blocks the virtual character, the touch control is displayed semi-transparently; alternatively, in a case that the touch control is scaled down to its minimum size but still blocks the virtual character, only the outline of the touch control is displayed.

In this way, by adjusting the display mode of the touch control based on the relationship between the touch control and the virtual character, the display of the touch control is prevented from blocking the virtual character, thus improving the user experience of the application program.

To sum up, in the method provided in this aspect, by adjusting the position of the touch control to the click/tap hot zone, i.e., the high-frequency click/tap region of the user, the layout of the touch control more conforms to the use habits of the user, thus improving the convenience in operation, optimizing the layout of the touch control on the user interface, and improving the user experience.

In addition, in the method provided in this aspect, by setting the candidate sub-regions in the predicted region statically or dynamically, the candidate sub-regions can be flexibly selected based on the preset manner or the landing points of the touch operations, thus improving the accuracy and efficiency of determining the second position.

Besides, in the method provided in this aspect, by adjusting the size of the touch control, the space of the user interface can be used as much as possible without affecting the use of other touch controls, thus improving the use efficiency of the touch control and optimizing the user experience.

In an illustrative aspect shown in FIG. 5, the second location is determined by the terminal or the client running on the terminal. In addition, the second location may also be determined by the server. This method is demonstrated through the following aspect.

FIG. 7 is a flowchart of a method for displaying a touch control according to an illustrative aspect described herein. The method may be executed by the terminal or the client on the terminal in the system shown in FIG. 3. The method includes the following operations:
Operation 320: Display the touch control by using a first position in a user interface as a display position of the touch control.

The user interface is an interface for interaction between a user and the terminal or the client on the terminal.

The first position refers to a position where the touch control is located before position adjustment. For example, on the initial interface at the beginning of the game, the first position where the touch control is located is determined based on the layout preset in the system. Alternatively, in a case that the user customizes the layout of the touch control on the user interface, the first position where the touch control is located is determined based on the custom layout.

Illustratively, the first position of the touch control is determined based on the default settings of the system or the custom settings of the user. The touch control is displayed at the first position in the user interface.
Operation 330: Receive a plurality of touch operation instructions generated by performing a plurality of touch operations on the touch control; and determine a plurality of touch operation positions respectively corresponding to the plurality of touch operation instructions on the user interface.

The touch operations refer to operations triggered on the touch control, and may be at least one of click/tap operations, long press operations, drag operations, double-click/tap operations, voice operations, pressure touch operations, eye gaze controls, and motion sensing control, which are not limited in this application. The touch operation instructions are computer instructions generated by the terminal in response to the touch operations triggered by the user, and the terminal needs to perform related operations based on the touch operation instructions. The touch operation instructions may indicate the control positions of the corresponding touch operations in the user interface, i.e., the touch operation positions.

The touch operations on the touch control refer to that a target object of the touch operations is the touch control, but the touch operations may not necessarily fall accurately on the touch control. That is, the touch operations on the touch control include touch operations that fall onto the touch control and touch operations that fall around the touch control.

In some aspects, a predicted region for the touch control is set, and the predicted region is a predicted region where the touch operations on the touch control may fall. In this aspect described herein, any touch operations that fall within the predicted region for the touch control are considered as operations on the touch control and will be recorded accordingly to provide reference for adjusting the display position of the touch control in the future, that is, the plurality of touch operations on the touch control described above are all touch operations that fall within the predicted region for the touch control. The predicted region is a region that includes the touch control and has an area larger than the area of the touch control in the user interface. In some aspects, the predicted region does not cover the regions of other touch controls. In practical application, the touch operations triggered by the user on the touch control may fall onto positions outside the touch control in the predicted region. When a plurality of touch operations triggered by the user on the touch control fall onto positions outside the touch control in the predicted region, it may be considered that the display position of the touch control does not conform to the operating habits of the user. In this case, the display position of the touch control may be adjusted based on touch operation positions of the plurality of touch operations triggered by the user on the touch control, so that the adjusted position conforms to the operating habits of the user.
Operation 340: Transmit an operation record for indicating the plurality of touch operation positions to a server.

Illustratively, after receiving a plurality of touch operation instructions generated by performing a plurality of touch operations on the touch control, the terminal transmits an operation record containing touch operation positions respectively corresponding to the plurality of touch operation instructions to the server. The operation record includes the operation positions of the plurality of touch operations, such as the click/tap positions of click/tap operations.
Operation 350: Receive second position information transmitted by the server.

The second position information is configured for indicating a second position of the touch control after position adjustment. The second position information is the coordinates of the second position; alternatively, the second position information is the offset data of the second position relative to the first position.

Illustratively, after the server determines the second position based on the touch operation positions of the plurality of touch operations, the server includes the second position in the second position information and transmits it to the terminal. The terminal receives the second position information transmitted by the server.

In some aspects, the terminal receives the second position information transmitted by the server. The second position information is configured for indicating the second position. The second position information is determined by the server based on the operation record for indicating the touch operation positions of the plurality of touch operations. That is, the server may determine the click/tap rate of each candidate sub-region within a predicted region based on the touch operation positions that fall within the predicted region among the plurality of touch operation positions, and determine a candidate sub-region with the click/tap rate reaching a first threshold as a first click/tap hot zone. The predicted region is a region that includes the touch control and has an area larger than the area of the touch control in the user interface. The specific manner that the server determines the first click/tap hot zone based on the click/tap rate is similar to the manner that the terminal determines the first click/tap hot zone based on the click/tap rate described above. For details, please refer to the relevant description above.

In some other aspects, the terminal receives the second position information transmitted by the server. The second position information is configured for indicating the second position. The second position information is determined by the server based on the operation record for indicating the touch operation positions of the plurality of touch operations. That is, the server may determine the number of clicks/taps of each candidate sub-region within a predicted region based on the touch operation positions that fall within the predicted region among the plurality of touch operation positions, and determine a candidate sub-region with the number of clicks/taps reaching a second threshold as a second click/tap hot zone. The predicted region is a region that includes the touch control and has an area larger than the area of the touch control in the user interface. The specific manner that the server determines the second click/tap hot zone based on the number of clicks/taps is similar to the manner that the terminal determines the second click/tap hot zone based on the number of clicks/taps described above. For details, please refer to the relevant description above.
Operation 360: Adjust the display position from the first position to a second position in the user interface based on the plurality of touch operation positions, and display the touch control at the second position.

Illustratively, the terminal may determine the second position based on the received second position information; display the position-adjusted touch control at the second position in the user interface.

To sum up, in the method provided in this aspect, by determining the adjusted display position of the touch control based on the touch operation positions of the plurality of touch operations through the server, the processing pressure of the terminal can be reduced, thus reducing the resource consumption of the terminal, and preventing the progress of other services on the terminal from being affected. In addition, by adjusting the position of the touch control to the click/tap hot zone, i.e., the high-frequency click/tap region of the user, the layout of the touch control more conforms to the use habits of the user, thus improving the convenience in operation, optimizing the layout of the touch control on the user interface, and improving the user experience.

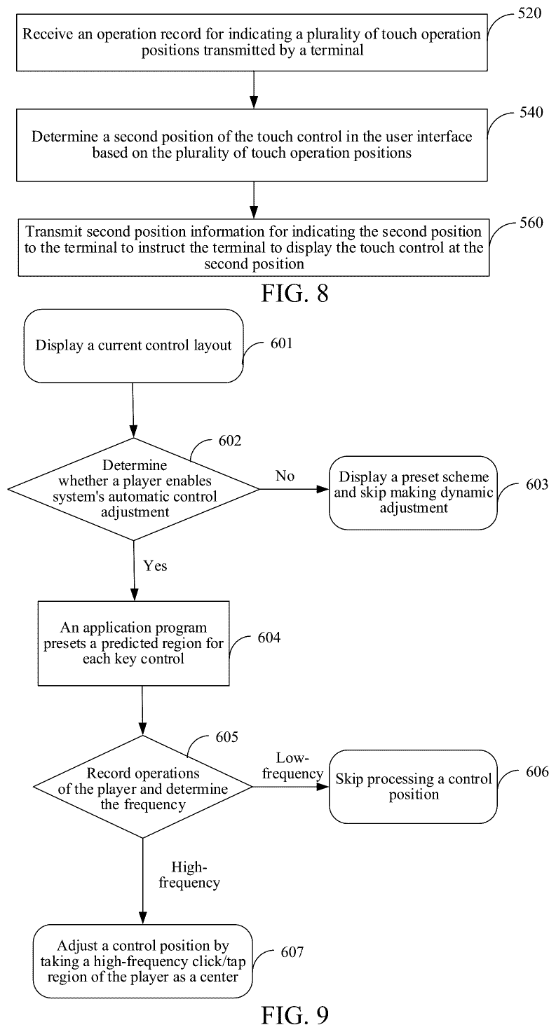

FIG. 8 is a flowchart of a method for displaying a touch control according to an illustrative aspect described herein. The method may be executed by the server in the system shown in FIG. 3. The method includes the following operations:
Operation 520: Receive an operation record for indicating a plurality of touch operation positions transmitted by a terminal.

The plurality of touch operation positions respectively correspond to a plurality of touch operation instructions, and the plurality of touch operation instructions are generated by performing a plurality of touch operations on the touch control. The touch operations refer to operations triggered on the touch control, and may be at least one of click/tap operations, long press operations, drag operations, double-click/tap operations, voice operations, pressure touch operations, eye gaze controls, and motion sensing control, which are not limited in this application. The touch operation instructions are computer instructions generated by the terminal in response to the touch operations triggered by the user, and the terminal needs to perform related operations based on the touch operation instructions. The touch operation instructions may indicate the control positions of the corresponding touch operations in the user interface, i.e., the touch operation positions.

The touch operations on the touch control refer to that a target object of the touch operations is the touch control, but the touch operations may not necessarily fall accurately on the touch control. That is, the touch operations on the touch control include touch operations that fall onto the touch control and touch operations that fall around the touch control. Illustratively, the server receives an operation record for indicating a plurality of touch operation positions transmitted by a terminal. The operation record may also indicate the operation time, operation type, and so on of a plurality of touch operations.
Operation 540: Determine a second position of the touch control in the user interface based on the plurality of touch operation positions.

The second position is obtained by adjusting a first position based on the plurality of touch operation positions, and the first position is a display position of the touch control in the user interface before position adjustment. That is, the second position is obtained by adjusting a first position where the touch control is originally displayed based on the operation positions of the plurality of touch operation, and the first position is a position of the touch control before position adjustment.

In some aspects, the second position is determined based on a first click/tap hot zone, and it may be the center position of the first click/tap hot zone, for example. The first click/tap hot zone is a region with the click/tap rate reaching a first threshold. The click/tap rate of the first click/tap hot zone is determined based on the number of the touch operation positions that fall within the first click/tap hot zone among the multiple touch operation positions.

Illustratively, the click/tap rate of each candidate sub-region within a predicted region is determined based on the touch operation positions that fall within a predicted region among the plurality of touch operation positions. The predicted region is a region that includes the touch control and has an area larger than the area of the touch control in the user interface. A candidate sub-region with the click/tap rate reaching the first threshold is determined as the first click/tap hot zone.

In this way, statistically counting the click/tap rate of each candidate sub-region in the predicted region and determining the first click/tap hot zone based on the click/tap rate can ensure that the determined first click/tap hot zone is a region frequently clicked/tapped by the user when triggering touch operations on the touch control. Correspondingly, determining the second position based on the first click/tap hot zone and adjusting the display position of the touch control to the second position can ensure that the adjusted touch control more conforms to the operating habits of the user.

In some aspects, the second position is determined based on a second click/tap hot zone, and may be the center position of the second click/tap hot zone, for example. The second click/tap hot zone is a region with the number of clicks/taps reaching a second threshold. The number of clicks/taps of the second click/tap hot zone is the number of touch operation positions that belong to the second click/tap hot zone among the multiple touch operation positions.

Illustratively, the number of clicks/taps of each candidate sub-region within a predicted region is determined based on the touch operation positions that fall within a predicted region among the plurality of touch operation positions. The predicted region is a region that includes the touch control and has an area larger than the area of the touch control in the user interface. A candidate sub-region with the number of clicks/taps reaching the second threshold is determined as the second click/tap hot zone.

In this way, statistically counting the number of clicks/taps of each candidate sub-region in the predicted region and determining the second click/tap hot zone based on the number of clicks/taps can ensure that the determined second click/tap hot zone is a region frequently clicked/tapped by the user when triggering touch operations on the touch control. Correspondingly, determining the second position based on the second click/tap hot zone and adjusting the display position of the touch control to the second position can ensure that the adjusted touch control more conforms to the operating habits of the user.

In some aspects, a predicted region for the touch control is set. The predicted region is a predicted region where the touch operations on the touch control may fall. The predicted region is a region in the user interface that includes the touch control and has an area larger than the area of the touch control. In this aspect described herein, any touch operations that fall within the predicted region for the touch control are considered as touch operations on the touch control and will be recorded accordingly to provide reference for adjusting the display position of the touch control in the future, that is, the plurality of touch operations on the touch control described above are all touch operations that fall within the predicted region for the touch control. In some aspects, the predicted region does not cover the regions of other touch controls. In practical application, the touch operations triggered by the user on the touch control may fall onto positions outside the touch control in the predicted region. When a plurality of touch operations triggered by the user on the touch control fall onto positions outside the touch control in the predicted region, it may be considered that the display position of the touch control does not conform to the operating habits of the user. In this case, the display position of the touch control may be adjusted based on touch operation positions of the plurality of touch operations triggered by the user on the touch control, so that the adjusted position conforms to the operating habits of the user.

In some aspects, the predicted region is divided into a plurality of candidate sub-regions. A manner of setting the candidate sub-regions includes any one of: dividing the predicted region into a plurality of rectangular candidate sub-regions that do not overlap with each other; dividing the predicted region into a plurality of sector-shaped candidate sub-regions that do not overlap with each other; setting a plurality of circular candidate sub-regions that have the same radius and partially overlap with each other in the predicted region by taking a center of the predicted region as a reference position; setting a plurality of circular candidate sub-regions that have the same radius and partially overlap with each other in the predicted region by taking a center of the touch control as a reference position; and setting a plurality of circular candidate sub-regions that have the same radius in the predicted region by taking the operation position of each touch operation as a center.

FIG. 6 shows a schematic diagram of a plurality of candidate sub-regions set in the predicted region. In (a), taking the predicted region being rectangular as an example, the predicted region is divided into a plurality of rectangular candidate sub-regions that do not overlap with each other by adopting a grid pattern dividing manner. In (b), taking the predicted region being circular as an example, the predicted region is divided into a plurality of sector-shaped candidate sub-regions that do not overlap with each other by adopting a sector dividing manner. In (c), the dashed circle indicates the touch control, the rectangular box indicates the predicted region, and the solid circles indicate the candidate sub-regions. A plurality of circular candidate sub-regions that have the same radius and partially overlap with each other are set in the predicted region by taking a center of the predicted region (i.e., the rectangular box) as a reference position. In (d), the dashed circle indicates the touch control, the rectangular box indicates the predicted region, and the solid circles indicate the candidate sub-regions. A plurality of circular candidate sub-regions that have the same radius and partially overlap with each other are set in the predicted region by taking a center of the touch control (i.e., the dashed circle) as a reference position. If the set candidate sub-regions exceed the predicted region, only valid operation records falling within the predicted region will be statistically counted, and invalid operation records outside the predicted region will be ignored.

In addition, manners (a) and (b) in FIG. 6 may also be implemented as partially overlapping candidate sub-regions, while manners (c) and (d) may also be implemented as non-overlapping candidate sub-regions, which is not limited in this application.

In addition to the manners of setting the candidate sub-regions shown in FIG. 6, candidate sub-regions may also be dynamically set based on the touch operations of the user. For example, a plurality of circular candidate sub-regions that have the same radius or a plurality of rectangular candidate sub-regions that have the same size are set in the predicted region by taking the operation position of each touch operation as a center.

Through the manners of setting the candidate sub-regions described above, the distribution of the touch operations that fall within the predicted region among the plurality of touch operations in the predicted region, i.e., how many touch operations there are at different positions in the predicted region, can be determined. Therefore, it is conducive to statistically counting the click/tap rate or the number of clicks/taps of different candidate sub-regions within the predicted region accordingly, thus more accurately determining the first click/tap hot zone or the second click/tap hot zone described above

In some aspects, in a case that the number of invalid operations that fall within the predicted region but do not fall onto the touch control among the plurality of touch operations exceeds a first invalidity threshold within a first time threshold, the process of determining the second position is triggered. The first time threshold is a preset time threshold, and the first invalidity threshold is a preset number-of-click/tap threshold. That is, if the touch operation positions of the user frequently fall around the touch control within a certain time period, adaptive position adjustment of the touch control is initiated.

In some aspects, in a case that the distance between the center position of the plurality of touch operation positions and the center position of the touch control is greater than a second invalidity threshold within a second time threshold, the process of determining the second position is triggered. The second time threshold is a preset time threshold, and the second invalidity threshold is a preset distance threshold. That is, if the high-frequency operation region of the touch operations of the user is far from the center of the touch control within a certain time period, adaptive position adjustment of the touch control is initiated.

In this way, through the above determination mechanism, the display position of the touch control is adjusted in a timely manner based on the operating habits of the user, so that the display position of the touch control quickly adapts to the operating habits of the user.

In addition to adjusting the position of the touch control described above, the size of the touch control may also be adjusted.

In some aspects, the size of the touch control is adjusted based on the size and/or resolution of the user interface. For example, the size ratio of the user interface to a preset interface is determined based on the size and/or resolution of the user interface. The size of the touch control is adjusted based on the ratio.

In some aspects, the size of the touch control is adjusted based on the distance between the touch control and an adjacent touch control. For example, in a case that the distance between the touch control and an adjacent touch control is less than a distance threshold, the touch control is scaled down. In a case that the distance between the touch control and an adjacent touch control is greater than a distance threshold, the touch control is scaled up.

In some aspects, the size of the touch control is adjusted based on the operation positions of the plurality of touch operations; alternatively, the size of the touch control is adjusted based on the operation positions of invalid operations that fall outside the touch control but belong to the predicted region among the plurality of touch operations.

For example, the size of the touch control is adjusted based on the size of a click/tap hot zone. The click/tap hot zone is a region with the click/tap rate and/or the number of clicks/taps reaching a click/tap threshold. The click/tap rate is determined based on the number of touch operations that fall within the click/tap hot zone among the plurality of touch operations. The click/tap hot zone may be specifically the first click/tap hot zone or the second click/tap hot zone described above. In some aspects, the size of the click/tap hot zone is used as the size of the touch control; alternatively, the size of the smallest circle including the click/tap hot zone is determined as the size of the touch control; alternatively, the size of the smallest rectangle including the click/tap hot zone is determined as the size of the touch control; alternatively, in a case that the size of the click/tap hot zone is much smaller than the size of the touch control, the size of the touch control is scaled down; further alternatively, in a case that the size of the click/tap hot zone is similar to the size of the touch control, the size of the touch control is appropriately scaled up, and so on.

For another example, the size of the touch control is adjusted based on the operation positions of invalid operations that fall within the predicted region but do not fall onto the touch control. For example, the size of the touch control is appropriately scaled up based on the distribution of the invalid operations, so as to ensure that as many touch operations as possible fall within the valid region without affecting other touch controls.

In some aspects, after adjusting the size of the touch control based on the operation positions of the plurality of touch operations, the click/tap threshold is adjusted based on the distance between the touch control and an adjacent touch control. The click/tap threshold may be a click/tap threshold for triggering the determination of the second position, or may be a click/tap threshold based on which the click/tap hot zone is determined. For example, in a case that the distance between the touch control with the size adjusted and an adjacent touch control is less than the distance threshold, the click/tap threshold is increased. In a case that the distance between the touch control with the size adjusted and an adjacent touch control is greater than the distance threshold, the click/tap threshold is decreased.

In addition to adjusting the size of the touch control, transparency adjustment and other manners may also be used to ensure that the touch control displayed at the second position does not block the user interface. For example, in a case that the touch control blocks the virtual character in the user interface, the touch control is scaled down; alternatively, in a case that the touch control blocks the virtual character in the user interface, the touch control is displayed semi-transparently; alternatively, in a case that the touch control blocks the virtual character in the user interface, only the outline of the touch control is displayed.

In some aspects, in a case that the touch control is scaled down to its minimum size but still blocks the virtual character, the touch control is displayed semi-transparently; alternatively, in a case that the touch control is scaled down to its minimum size but still blocks the virtual character, only the outline of the touch control is displayed.
Operation 560: Transmit second position information for indicating the second position to the terminal to instruct the terminal to display the touch control at the second position.

Illustratively, after determining the second position of the touch control, the server transmits second position information for indicating the second position to the terminal to instruct the terminal to display the touch control at the second position. The second position information is the coordinates of the second position or the offset of the second position relative to the first position. The first position refers to a position where the touch control is located before position adjustment.

In some aspects, the server further transmits the size information of the touch control to the terminal.

To sum up, in the method provided in this aspect described herein, by determining the adjusted display position of the touch control based on the touch operation positions of the plurality of touch operations through the server, the processing pressure of the terminal can be reduced, thus reducing the resource consumption of the terminal, and preventing the progress of other services on the terminal from being affected. Moreover, by determining the second position of the touch control based on the plurality of touch operation positions on the touch control, the position of the touch control can be adjusted based on the high-frequency click/tap region of the user, thus improving the use efficiency of the touch control, optimizing the layout of the user interface, and improving the user experience.

FIG. 9 is a flowchart of a method for displaying a touch control according to an illustrative aspect described herein. The method includes the following operations:
Operation 601: Display a current control layout.

Illustratively, a user interface is displayed. The current control layout is displayed on the user interface, that is, the touch control is displayed at a first position in the user interface.
Operation 602: Determine whether a player enables system's automatic control adjustment.

Illustratively, the player is asked whether to agree to enable a system's automatic touch control adjustment function. If yes, operation 604 is performed; if no, operation 603 is performed.

The user information and data involved in this application are authorized by the user or fully authorized by all parties, and the collection, use, and processing of relevant data comply with relevant laws, regulations, and standards of relevant countries and regions.
Operation 603: Display a preset scheme and skip making dynamic adjustment.

In a case that the player does not agree to enable the system's automatic touch control adjustment function, the user interface will display a preset touch control layout scheme without making dynamic adjustment of the touch control.
Operation 604: An application program presets a predicted region for each key control.

In a case that the player agrees to enable the system's automatic touch control adjustment function, an application program (such as game application program) will preset a predicted region for each key touch control. The predicted region covers the touch control and has an area larger than the area of the touch control. Key controls refer to touch controls that have important functions or may be frequently used by the user during operations.

For example, a screen region is divided into a plurality of rectangular regions based on the screen resolution and ratio of the terminal, and each rectangular region represents a hot zone and is configured for recording click/tap positions of the player.
Operation 605: Record operations of the player and determine the frequency.

The touch operations that fall within the predicted region for the touch control are recorded, and the distribution of operation frequency is determined based on the operation record of the player. For example, whenever the player clicks/taps on a touch control, the number of times that a click/tap hot zone is clicked/tapped is recorded based on the click/tap hot zone where the click/tap position is located.

For a high-frequency operation region, operation 607 is performed; for a low-frequency operation region, operation 606 is performed.
Operation 606: Skip processing a control position.

For the touch control in a low-frequency operation region, its position is not changed.

Alternatively, in another implementation, the touch control in a low-frequency operation region may be adjusted to any other region without a touch control, so as to free up more space for high-frequency operated touch controls.
Operation 607: Adjust a control position by taking a high-frequency click/tap region of the player as a center.

For the touch control in a high-frequency operation region, a high-frequency click/tap region (i.e., click/tap hot zone) for the touch control is determined based on the operation record of the touch operations of the user, and the touch control is adjusted to the high-frequency click/tap region to make the touch operations of the player more accurate.

In some aspects, adjustable customization options are provided. To meet the personalized needs of different players, adjustable customization options may be provided, so that the players can manually adjust the position of the touch control to better conform to their operating habits.

In some aspects, an adjustment algorithm is continuously optimized. In order to better adapt to the operating habits of the player and the change of the game scene, the adjustment algorithm may be continuously optimized. Based on player feedback and data analysis, the hot zone division and adaptive adjustment mechanism is continuously improved to enhance the gaming experience of the player.

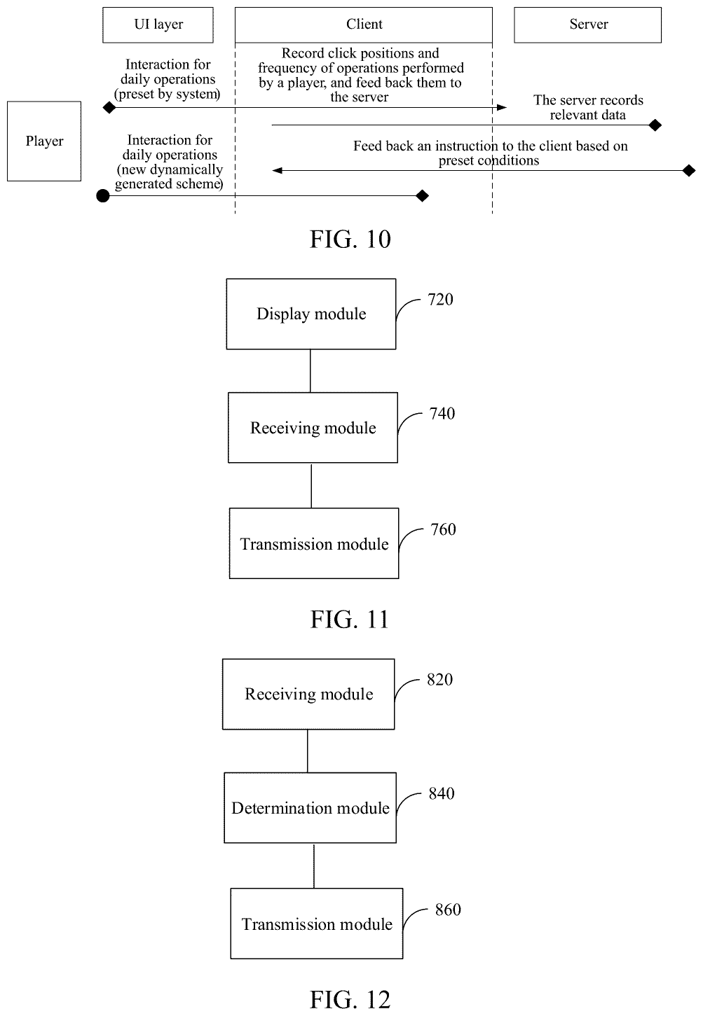

FIG. 10 is a schematic diagram of interaction among a User Interface (UI) layer, a client and a server in a method for displaying a touch control according to an illustrative aspect described herein.

The UI layer is a final experience layer, can be perceived and interacted with by the players in real time, and generates visual representations of differentiated schemes based on data processing at a front end and a back end. The players interact with each other for daily operations through the UI layer. In an initial state, the UI layer is the layout preset by the system.

The client is configured to preset a predicted region for reach touch control and set conditions for dynamic adjustment of the touch control, such as click/tap rate thresholds. The client records the click/tap positions and frequency of the touch operations performed by the player, and feeds back an operation record to the server.

After receiving the operation record transmitted by the client, the server records relevant data, summarizes and statistically collects the operation record of the player, and feeds back an instruction to the client based on the preset conditions to indicate the adjusted position of the touch control on the client.

Finally, the client dynamically adjusts the position of the touch control in real time based on the feedback instruction from the server, and presents it at the UI layer.

FIG. 11 shows a schematic structural diagram of an apparatus for displaying a touch control according to an illustrative aspect described herein. The apparatus may be implemented as all or part of a computer device through software, hardware, or a combination thereof. The apparatus includes:

a display module 720 configured to display the touch control by using a first position in a user interface as a display position of the touch control; and
a receiving module 740 configured to receive a plurality of touch operation instructions generated by performing a plurality of touch operations on the touch control, and determine a plurality of touch operation positions respectively corresponding to the plurality of touch operation instructions on the user interface.

The display module 720 is further configured to adjust the display position from the first position to a second position in the user interface based on the plurality of touch operation positions, and display the touch control at the second position.

In a possible implementation, the second position is determined based on a first click/tap hot zone, the first click/tap hot zone is a region with the click/tap rate reaching a first threshold, and the click/tap rate of the first click/tap hot zone is determined based on the number of the touch operation positions that fall within the first click/tap hot zone among the plurality of touch operation positions.

In a possible implementation, the display module 720 is further configured to determine the click/tap rate of each candidate sub-region within a predicted region based on the touch operation positions that fall within the predicted region among the plurality of touch operation positions, the predicted region being a region that includes the touch control and has an area larger than the area of the touch control; and determine a candidate sub-region with the click/tap rate reaching the first threshold as the first click/tap hot zone.

In a possible implementation, the apparatus further includes a transmission module 760. The transmission module 760 is configured to transmit an operation record for indicating the plurality of touch operation positions to a server; the receiving module 740 is configured to receive second position information transmitted by the server, the second position information is configured for indicating the second position, the second position information is determined by the server based on the operation record, and the server is configured to determine the click/tap rate of each candidate sub-region within a predicted region based on the touch operation positions that fall within the predicted region among the plurality of touch operation positions, and determine a candidate sub-region with the click/tap rate reaching the first threshold as the first click/tap hot zone.

In a possible implementation, the second position is determined based on a second click/tap hot zone, the second click/tap hot zone is a region with the number of clicks/taps reaching a second threshold, and the number of clicks/taps of the second click/tap hot zone is determined based on the number of the touch operation positions that belong to the second click/tap hot zone among the plurality of touch operation positions.

In a possible implementation, the display module 720 is further configured to determine the number of clicks/taps of each candidate sub-region within a predicted region based on the touch operation positions that fall within the predicted region among the plurality of touch operation positions, the predicted region being a region that includes the touch control and has an area larger than the area of the touch control; and determine a candidate sub-region with the number of clicks/taps reaching the second threshold as the second click/tap hot zone.

In a possible implementation, the transmission module 760 is configured to transmit an operation record for indicating the plurality of touch operation positions to a server; the receiving module 740 is configured to receive second position information transmitted by the server, the second position information is configured for indicating the second position, the second position information is determined by the server based on the operation record, the server is configured to determine the number of clicks/taps of each candidate sub-region within a predicted region based on the touch operation positions that fall within the predicted region among the plurality of touch operation positions, and determine a candidate sub-region with the number of clicks/taps reaching the second threshold as the second click/tap hot zone, and the predicted region is a region that includes the touch control and has an area larger than the area of the touch control in the user interface.

In a possible implementation, the second position information is the coordinates of the second position; alternatively, the second position information is the offset data of the second position relative to the first position.

In a possible implementation, a manner of setting the candidate sub-regions includes any one of: dividing the predicted region into a plurality of rectangular candidate sub-regions that do not overlap with each other; dividing the predicted region into a plurality of sector-shaped candidate sub-regions that do not overlap with each other; setting a plurality of circular candidate sub-regions that have the same radius and partially overlap with each other in the predicted region by taking a center of the predicted region as a reference position; setting a plurality of circular candidate sub-regions that have the same radius and partially overlap with each other in the predicted region by taking a center of the touch control as a reference position; and setting a plurality of circular candidate sub-regions that have the same radius in the predicted region by taking each of the touch operation positions as a center.

In a possible implementation, the display module 720 is further configured to adjust the size of the touch control based on the size and/or resolution of the user interface.

In a possible implementation, the display module 720 is further configured to adjust the size of the touch control based on the plurality of touch operation positions; alternatively, adjust the size of the touch control based on the touch operation positions corresponding to invalid operations that fall outside the touch control but belong to a predicted region of the plurality of touch operation positions; the predicted region is a region that includes the touch control and has an area larger than the area of the touch control in the user interface.

FIG. 12 shows a schematic structural diagram of an apparatus for displaying a touch control according to an illustrative aspect described herein. The apparatus may be implemented as all or part of a computer device through software, hardware, or a combination thereof. The apparatus includes:
a receiving module 820 configured to receive an operation record for indicating a plurality of touch operation positions transmitted by a terminal, the plurality of touch operation positions respectively corresponding to a plurality of touch operation instructions, the plurality of touch operation instructions being generated by performing a plurality of touch operations on the touch control;
a determination module 840 configured to determine a second position of the touch control in the user interface based on the plurality of touch operation positions, the second position being obtained by adjusting a first position based on the plurality of touch operation positions, the first position being a display position of the touch control in the user interface before position adjustment; and
a transmission module 860 configured to transmit second position information for indicating the second position to the terminal to instruct the terminal to display the touch control at the second position.

In a possible implementation, the second position is determined based on a first click/tap hot zone, the first click/tap hot zone is a region with the click/tap rate reaching a first threshold, and the click/tap rate of the first click/tap hot zone is determined based on the number of the touch operation positions that fall within the first click/tap hot zone among the plurality of touch operation positions.

In a possible implementation, the determination module 840 is configured to determine the click/tap rate of each candidate sub-region within a predicted region based on the touch operation positions that fall within the predicted region among the plurality of touch operation positions, the predicted region being a region that includes the touch control and has an area larger than the area of the touch control in the user interface; and determine a candidate sub-region with the click/tap rate reaching the first threshold as the first click/tap hot zone.

In a possible implementation, the second position is determined based on a second click/tap hot zone, the second click/tap hot zone is a region with the number of clicks/taps reaching a second threshold, and the number of clicks/taps of the second click/tap hot zone is determined based on the number of the touch operation positions that belong to the second click/tap hot zone among the plurality of touch operation positions.

In a possible implementation, the determination module 840 is configured to determine the number of clicks/taps of each candidate sub-region within a predicted region based on the touch operation positions that fall within the predicted region among the plurality of touch operation positions, the predicted region being a region that includes the touch control and has an area larger than the area of the touch control in the user interface; and determine a candidate sub-region with the number of clicks/taps reaching the second threshold as the second click/tap hot zone.

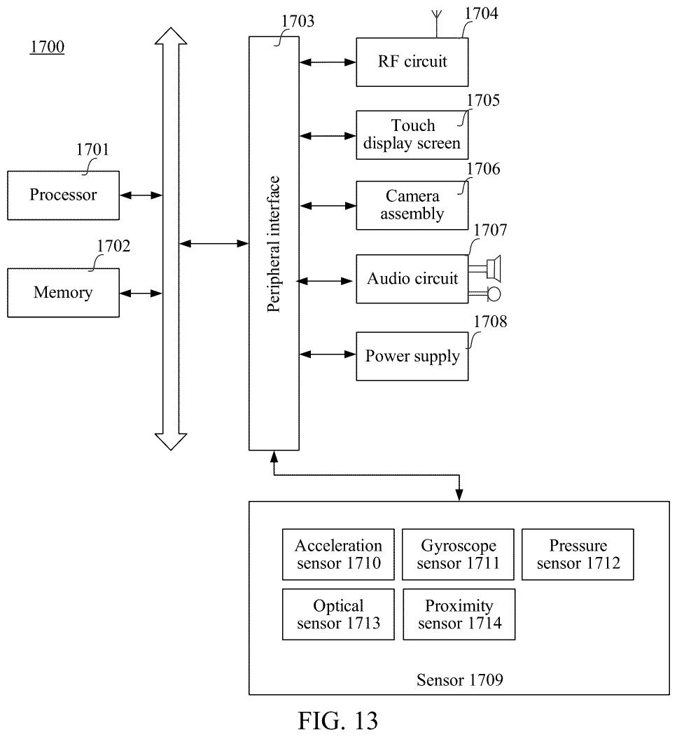

FIG. 13 is a structural block diagram of a computer device 1700 according to an illustrative aspect described herein. The computer device 1700 may be a portable mobile terminal, such as a smart phone, a tablet computer, a Moving Picture Experts Group Audio Layer III (MP3) player, or a Moving Picture Experts Group Audio Layer IV (MP4) player. The computer device 1700 may also be referred to as another name such as user equipment or portable terminal.

Generally, the computer device 1700 includes: a processor 1701 and a memory 1702.

The processor 1701 may include one or more processing cores, for example, a 4-core processor or an 8-core processor. The processor 1701 may be implemented in at least one hardware form of a Digital Signal Processor (DSP), a Field-Programmable Gate Array (FPGA), and a Programmable Logic Array (PLA). The processor 1701 may also include a main processor and a coprocessor. The main processor is configured to process data in an active state, also referred to as a Central Processing Unit (CPU). The coprocessor is a low power consumption processor configured to process data in a standby state. In some aspects, the processor 1701 may be integrated with a Graphics Processing Unit (GPU). The GPU is configured to render and draw content that needs to be displayed on a display screen. In some aspects, the processor 1701 may further include an Artificial Intelligence (AI) processor. The AI processor is configured to process computing operations related to machine learning.

The memory 1702 may include one or more computer-readable storage media. The computer-readable storage media may be tangible and non-transitory. The memory 1702 may further include a high-speed random access memory and a nonvolatile memory, for example, one or more disk storage devices or flash storage devices. In some aspects, the non-transient computer-readable storage medium in the memory 1702 is configured to store at least one instruction, and the at least one instruction is executed by the processor 1701 to implement the method for displaying the touch control provided in the aspect described herein.

In some aspects, the computer device 1700 may include, for example, a peripheral interface 1703 and at least one peripheral. Specifically, the peripheral includes: at least one of a Radio Frequency (RF) circuit 1704, a touch display screen 1705, a camera component 1706, an audio circuit 1707, and a power supply 1708.

The peripheral interface 1703 may be configured to connect the at least one peripheral related to Input/Output (I/O) to the processor 1701 and the memory 1702. In some aspects, the processor 1701, the memory 1702, and the peripheral interface 1703 are integrated on the same chip or circuit board. In some other aspects, any one or two of the processor 1701, the memory 1702, and the peripheral interface 1703 may be implemented on an independent chip or circuit board, which is not limited in this aspect.

The RF circuit 1704 is configured to receive and transmit an RF signal, also referred to as an electromagnetic signal. The RF circuit 1704 communicates with a communication network and other communication devices through the electromagnetic signal. The RF circuit 1704 converts an electric signal into an electromagnetic signal for transmission, or converts a received electromagnetic signal into an electric signal. In some aspects, the RF circuit 1704 includes an antenna system, an RF transceiver, one or more amplifiers, a tuner, an oscillator, a digital signal processor, a codec chip set, a subscriber identity module card, and the like. The RF circuit 1704 may communicate with another terminal through at least one wireless communications protocol. The wireless communications protocol includes, but not limited to, a worldwide web, a metropolitan area network, an intranet, various generations of mobile communication networks (2G, 3G, 4G, and 5G), a wireless local area network, and/or a wireless fidelity (WiFi) network. In some aspects, the RF 1704 may further include a circuit related to NFC, which is not limited in this application.

The touch display screen 1705 is configured to display a User Interface (UI). The UI may include a graph, text, an icon, a video, and any combination thereof. The touch display screen 1705 further has a capability of acquiring a touch signal on or above a surface of the touch display screen 1705. The touch signal may be inputted to the processor 1701 as a control signal for processing. The touch display screen 1705 is configured to provide a virtual button and/or a virtual keyboard that are/is also referred to as a soft button and/or a soft keyboard. In some aspects, the number of the touch display screen 1705 may be one, which is arranged on a front panel of the computer device 1700. In some other aspects, the number of the touch display screens 1705 is at least two, which are arranged on different surfaces of the computer device 1700 respectively or in a folded design. In some aspects, the touch display screen 1705 may be a flexible display screen, which is arranged on a curved surface or a folded surface of the computer device 1700. Even, the touch display screen 1705 may be further configured in a non-rectangular irregular pattern, that is, it is a special-shaped screen. The touch display screen 1705 may be fabricated by using a material such as Liquid Crystal Display (LCD) or Organic Light-Emitting Diode (OLED).

The camera component 1706 is configured to capture images or videos. In some aspects, the camera assembly 1706 includes a front camera and a rear camera. Generally, the front camera is configured to implement a video call or self-portrait, and the rear camera is configured to shoot a picture or a video. In some aspects, the number of the rear cameras is at least two, each of which is any one of a main camera, a depth of field camera, and a wide-angle camera, so as to implement a background blurring function by fusing the main camera and the depth of field camera, and panoramic shooting and Virtual Reality (VR) shooting functions by fusing the main camera and the wide-angle camera. In some aspects, the camera component 1706 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1707 is configured to provide an audio interface between the user and the computer device 1700. The audio circuit 1707 may include a microphone and a speaker. The microphone is configured to acquire sound waves of a user and an environment, and convert the sound waves into an electric signal inputted to the processor 1701 for processing, or inputted to the radio frequency circuit 1704 for implementing voice communication. For the purpose of stereo acquisition or noise reduction, there may be a plurality of microphones, respectively arranged at different portions of the computer device 1700. The microphone may further be an array microphone or an omni-directional acquisition type microphone. The speaker is configured to convert an electric signal from the processor 1701 or the RF circuit 1704 into sound waves. The speaker may be a conventional film speaker, or may be a piezoelectric ceramic speaker. When the speaker is the piezoelectric ceramic speaker, it not only can convert an electric signal into acoustic waves audible to a human being, but also can convert an electric signal into acoustic waves inaudible to a human being for ranging and other purposes. In some aspects, the audio circuit 1707 may further include an earphone jack.

The power supply 1708 is configured to supply power to components in the computer device 1700. The power supply 1708 may be alternating current, direct current, a primary battery, or a rechargeable battery. When the power supply 1708 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some aspects, the computer device 1700 further includes one or more sensors 1709. The one or more sensors 1709 include, but not limited to, an acceleration sensor 1710, a gyroscope sensor 1711, a pressure sensor 1712, an optical sensor 1713, and a proximity sensor 1714.

The acceleration sensor 1710 may detect the magnitude of acceleration on three coordinate axes of a coordinate system established with the computer device 1700. For example, the acceleration sensor 1710 may be configured to detect components of gravity acceleration on the three coordinate axes. The processor 1701 may control, according to a gravity acceleration signal acquired by the acceleration sensor 1710, the touch display screen 1705 to display the user interface in a landscape view or a portrait view. The acceleration sensor 1710 may be further configured to acquire motion data of a game or a user.

The gyroscope sensor 1711 may detect a body direction and a rotation angle of the computer device 1700. The gyroscope sensor 1711 may cooperate with the acceleration sensor 1710 to acquire a 3D action by the user on the computer device 1700. The processor 1701 may implement the following functions according to the data acquired by the gyroscope sensor 1711: motion sensing (such as changing the UI according to a tilt operation of the user), image stabilization at shooting, game control, and inertial navigation.

The pressure sensor 1712 may be arranged one a side frame of the computer device 1700 and/or a lower layer of the touch display screen 1705. When the pressure sensor 1712 is arranged on the side frame of the computer device 1700, a holding signal of the user on the computer device 1700 may be detected, and left and right hand recognition or a quick operation may be performed according to the holding signal. When the pressure sensor 1712 is arranged on the low layer of the touch display screen 1705, an operable control on the UI may be controlled according to a pressure operation of the user on the touch display screen 1705. The operable control includes at least one of a button control, a scroll-bar control, an icon control, and a menu control.

The optical sensor 1713 is configured to acquire ambient light intensity. In an aspect, the processor 1701 may control the display brightness of the touch display screen 1705 according to the ambient light intensity acquired by the optical sensor 1713. Specifically, when the ambient light intensity is relatively high, the display brightness of the touch display screen 1705 is increased. When the ambient light intensity is relatively low, the display brightness of the touch display screen 1705 is decreased. In another aspect, the processor 1701 may further dynamically adjust a camera parameter of the camera component 1706 according to the ambient light intensity acquired by the optical sensor 1713.

The proximity sensor 1714, also referred to as a distance sensor, is generally arranged on a front surface of the computer device 1700. The proximity sensor 1714 is configured to acquire the distance between the user and the front surface of the computer device 1700. In an aspect, when the proximity sensor 1714 detects that the distance between the user and the front surface of the computer device 1700 gradually decreases, the processor 1701 controls the touch display screen 1705 to switch from a screen-on state to a screen-off state. When the proximity sensor 1714 detects that the distance between the user and the front surface of the computer device 1700 gradually increases, the processor 1701 controls the touch display screen 1705 to switch from the screen-off state to the screen-on state.

A person skilled in the art may understand that the structure shown in FIG. 13 constitutes no limitation on the computer device 1700, it may include more or fewer components than those shown in the figure, or some components may be combined, or a different component deployment may be adopted.

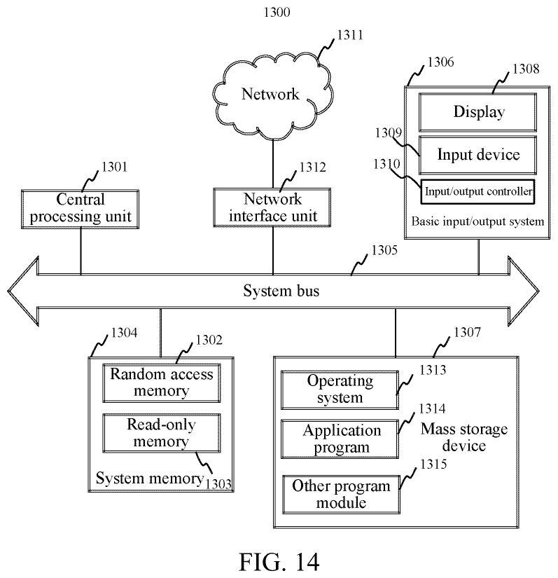

FIG. 14 is a schematic structural diagram of a server according to an illustrative aspect. The server 1300 includes a Central Processing Unit (CPU) 1301, a system memory 1304 including a Random Access Memory (RAM) 1302 and a Read-Only Memory (ROM) 1303, and a system bus 1305 connecting the system memory 1304 and the CPU 1301. The server 1300 further includes a basic input/output (I/O) system 1306 assisting in information transmission between components in the computer device, and a mass storage device 1307 configured to store an operating system 1313, an application program 1314, and another program module 1315.

The basic I/O system 1306 includes a display 1308 configured to display information and an input device 1309 such as a mouse or a keyboard that is configured for inputting information by a user. The display 1308 and the input device 1309 are both connected to the CPU 1301 through an input/output controller 1310 connected to the system bus 1305. The basic I/O system 1306 may further include the input/output controller 1310 configured to receive and process inputs from a plurality of other devices such as a keyboard, a mouse, and an electronic stylus. Similarly, the input/output controller 1310 further provides an output to a display screen, a printer, or another type of output device.

The mass storage device 1307 is connected to the CPU 1301 through a mass storage controller (not shown) connected to the system bus 1305. The mass storage device 1307 and a computer-readable medium associated therewith provide non-volatile storage for the server 1300. In other words, the mass storage device 1307 may include a computer-readable medium (not shown) such as a hard disk or a Compact Disc Read-Only Memory (CD-ROM) drive.

Without losing generality, the computer-readable medium may include a computer-readable storage medium and a communication medium. The computer-readable storage medium includes volatile and non-volatile media, and removable and non-removable media implemented by using any method or technology configured for storing information such as computer-readable instructions, data structures, program modules, or other data. The computer-readable storage medium includes an RAM, an ROM, an Erasable Programmable Read Only Memory (EPROM), an Electrically Erasable Programmable Read-Only Memory (EEPROM), a CD-ROM, a Digital Video Disc (DVD) or another optical memory, a tape cartridge, a magnetic cassette, a magnetic disk memory, or another magnetic storage device. Certainly, a person skilled in the art may learn that the computer-readable storage medium is not limited to the several types described above. The system memory 1304 and the mass storage device 1307 may be collectively referred to as a memory.

According to various aspects described herein, the server 1300 may be further connected, through a network such as the Internet, to a remote computer device on the network and run. That is, the server 1300 may be connected to a network 1311 through a network interface unit 1312 connected to the system bus 1305, or may be connected to another type of network or a remote computer device system (not shown) through the network interface unit 1312.

The memory further includes one or more programs. The one or more programs are stored in the memory. The central processing unit 1301 implements all or part of the operations of the method for displaying the touch control by executing the one or more programs.

An aspect described herein further provides a computer device. The computer device includes: a processor and a memory. The memory has at least one computer program stored therein. The at least one computer program is loaded and executed by the processor to implement the method for displaying the touch control provided in each method aspect described above.

An aspect described herein further provides a computer-readable storage medium. The computer-readable storage medium has at least one computer program stored therein. The at least one computer program is loaded and executed by a processor to implement the method for displaying the touch control provided in each method aspect described above.

An aspect described herein further provides a computer program product. The computer program product includes a computer program. The computer program is stored in a computer-readable storage medium. The computer program is read and executed by a processor of a computer device from the computer-readable storage medium, causing the computer device to implement the method for displaying the touch control provided in each method aspect described above.

“Plurality” mentioned in the description refers to two or more. “And/or” describes an association relationship for describing associated objects, and represents that three relationships may exist. For example, A and/or B may represent the following three cases: only A exists, both A and B exist, and only B exists. The character “/” in this specification generally indicates an “or” relationship between the associated objects.

A person of ordinary skill in the art may understand that all or some of the operations of the aspects may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely illustrative aspects described herein, but are not intended to limit this application. Any modification, equivalent replacement, or improvement made within the spirit and principle described herein shall fall within the protection scope described herein.

What is claimed is:

1. A computer-implemented method, comprising:
receiving a plurality of touch operation positions, the plurality of touch operation positions respectively corresponding to a plurality of touch operation instructions generated based on a plurality of touch operations on a touch control displayed at a first position in a user interface;
determining a second position of the touch control based on the plurality of touch operation positions, the second position being obtained by adjusting the first position based on the plurality of touch operation positions; and
outputting second position information for display of the touch control at the second position in the user interface.

2. The method of claim 1, wherein the second position is determined based on a first click/tap hot zone, the first click/tap hot zone being a region with a click/tap rate reaching a first threshold, and the click/tap rate of the first click/tap hot zone being determined based on a number of the touch operation positions that fall within the first click/tap hot zone among the plurality of touch operation positions.

3. The method of claim 1, further comprising:
determining a click/tap rate of one or more candidate sub-regions within a predicted region based on the touch operation positions that fall within the predicted region among the plurality of touch operation positions, the predicted region being a region that comprises the touch control and has an area larger than the area of the touch control in the user interface; and
determining a candidate sub-region with the click/tap rate reaching the first threshold as the first click/tap hot zone.

4. The method of claim 1 wherein receiving the plurality of touch operation positions comprises receiving, by a server, the plurality of touch operation positions from a terminal device, and wherein outputting second position information comprises transmitting, by the server, second position information to the terminal device.

5. The method of claim 2, wherein the second position is determined based on a second click/tap hot zone, the second click/tap hot zone is a region with a number of clicks/taps reaching a second threshold, and the number of clicks/taps of the second click/tap hot zone is the number of the touch operation positions that belong to the second click/tap hot zone among the plurality of touch operation positions.

6. The method according to claim 1, further comprising:
determining a number of clicks/taps of one or more candidate sub-regions within a predicted region based on the touch operation positions that fall within the predicted region among the plurality of touch operation positions, the predicted region being a region that comprises the touch control and has an area larger than the area of the touch control in the user interface; and
determining a candidate sub-region with the number of clicks/taps reaching the second threshold as the second click/tap hot zone.

7. The method of claim 1, further comprising:
transmitting an operation record for indicating the plurality of touch operation positions to a server; and
receiving second position information transmitted by the server, the second position information being configured for indicating the second position, the second position information being determined by the server based on the operation record, the server being configured to determine the number of clicks/taps of each candidate sub-region within a predicted region based on the touch operation positions that fall within the predicted region among the plurality of touch operation positions, and determine a candidate sub-region with the number of clicks/taps reaching the second threshold as the second click/tap hot zone, the predicted region being a region that comprises the touch control and has an area larger than the area of the touch control in the user interface.

8. The method of claim 1, wherein the second position information is coordinates of the second position; or
the second position information is offset data of the second position relative to the first position.

9. The method of claim 1, wherein a manner of setting the candidate sub-regions comprises any one of:
dividing the predicted region into a plurality of rectangular candidate sub-regions that do not overlap with each other;
dividing the predicted region into a plurality of sector-shaped candidate sub-regions that do not overlap with each other;
setting a plurality of circular candidate sub-regions that have a same radius and partially overlap with each other in the predicted region by taking a center of the predicted region as a reference position;
setting a plurality of circular candidate sub-regions that have a same radius and partially overlap with each other in the predicted region by taking a center of the touch control as a reference position; and
setting a plurality of circular candidate sub-regions that have a same radius in the predicted region by taking each of the touch operation positions as a center.

10. The method of claim 1, further comprising:
adjusting a size of the touch control based on a size and/or resolution of the user interface.

11. The method of claim 1, further comprising:
adjusting the size of the touch control based on the plurality of touch operation positions;
or
adjusting the size of the touch control based on the touch operation positions corresponding to invalid operations that fall outside the touch control but belong to a predicted region of the plurality of touch operation positions, the predicted region being a region that comprises the touch control and has an area larger than the area of the touch control in the user interface.

12. The method of claim 1, further comprising:
displaying the touch control at the first position in the user interface on a terminal device; and
after outputting second position information, displaying the touch control at the second position in the user interface on the terminal device.

13. One or more non-transitory computer storage media comprising computer readable instructions which, when executed, configure a data processing system to perform:
receiving a plurality of touch operation positions, the plurality of touch operation positions respectively corresponding to a plurality of touch operation instructions generated based on a plurality of touch operations on a touch control displayed at a first position in a user interface;
determining a second position of the touch control based on the plurality of touch operation positions, the second position being obtained by adjusting the first position based on the plurality of touch operation positions; and
outputting second position information for display of the touch control at the second position in the user interface.

14. The computer storage media of claim 13, wherein the second position is determined based on a first click/tap hot zone, the first click/tap hot zone being a region with a click/tap rate reaching a first threshold, and the click/tap rate of the first click/tap hot zone being determined based on a number of the touch operation positions that fall within the first click/tap hot zone among the plurality of touch operation positions.

15. The computer storage media of claim 13, further comprising:
determining a click/tap number and/or rate for one or more candidate sub-regions within a predicted region based on the touch operation positions that fall within the predicted region among the plurality of touch operation positions, the predicted region being a region that comprises the touch control and has an area larger than the area of the touch control in the user interface; and
determining a candidate sub-region when the respective determined click/tap number and/or rate reaching the first threshold as the first click/tap hot zone.

16. The computer storage media of claim 14, wherein the second position is determined based on a second click/tap hot zone, the second click/tap hot zone is a region with a number of clicks/taps reaching a second threshold, and the number of clicks/taps of the second click/tap hot zone is the number of the touch operation positions that belong to the second click/tap hot zone among the plurality of touch operation positions.

17. The computer storage media of claim 13, wherein a manner of setting the candidate sub-regions comprises any one of:
dividing the predicted region into a plurality of rectangular candidate sub-regions that do not overlap with each other;
dividing the predicted region into a plurality of sector-shaped candidate sub-regions that do not overlap with each other;
setting a plurality of circular candidate sub-regions that have a same radius and partially overlap with each other in the predicted region by taking a center of the predicted region as a reference position;
setting a plurality of circular candidate sub-regions that have a same radius and partially overlap with each other in the predicted region by taking a center of the touch control as a reference position; and
setting a plurality of circular candidate sub-regions that have a same radius in the predicted region by taking each of the touch operation positions as a center.

18. A data processing system, comprising:
a processor; and
memory storing computer readable instructions which, when executed by the processor, configure the data processing system to perform:
receiving a plurality of touch operation positions, the plurality of touch operation positions respectively corresponding to a plurality of touch operation instructions generated based on a plurality of touch operations on a touch control displayed at a first position in a user interface;
determining a second position of the touch control based on the plurality of touch operation positions, the second position being obtained by adjusting the first position based on the plurality of touch operation positions; and
outputting second position information for display of the touch control at the second position in the user interface.

19. The data processing system of claim 18, wherein the second position is determined based on a first click/tap hot zone, the first click/tap hot zone being a region with a click/tap rate reaching a first threshold, and the click/tap rate of the first click/tap hot zone being determined based on a number of the touch operation positions that fall within the first click/tap hot zone among the plurality of touch operation positions.

20. The data processing system of claim 18, further comprising:
determining a click/tap number and/or rate for one or more candidate sub-regions within a predicted region based on the touch operation positions that fall within the predicted region among the plurality of touch operation positions, the predicted region being a region that comprises the touch control and has an area larger than the area of the touch control in the user interface; and
determining a candidate sub-region when the respective determined click/tap number and/or rate reaching the first threshold as the first click/tap hot zone.
